(19) United States
(12) Patent Application Publication
(10) Pub. No.: US 2011/0004517 A1
(43) Pub. Date: Jan. 6, 2011

(54) DIALOGUE ADVERTISING

(75) Inventors: Santos Soto, San Francisco, CA (US); Marc Tenedora, Milpitas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Jungle U LLC, San Francisco, CA (US)

(21) Appl. No.: 12/823,416

(22) Filed: Jun. 25, 2010

Related U.S. Application Data
(60) Provisional application No. 61/220,973, filed on Jun. 26, 2009.
(60) Provisional application No. 61/220,976, filed on Jun. 26, 2009.

(51) Int. Cl. G06Q 30/00

(52) U.S. Cl. 705/14.51; 705/14.49

(57) ABSTRACT

Embodiments of the invention provide systems and methods for providing an interactive media player with e-commerce functions. According to one embodiment, a method of providing an interactive media player can comprise generating and displaying with a commerce management server a media player including content area, the content area adapted to display a selected content. The media player can also include a content library of available content, and a favorites area of the media player based on a user of the media player. An indication of the selected content can be received and the selected content can be played in the content area of the media player. An interactive ad can be selected based on the selected content and displayed in a lower third banner of the content area during playout of the selected content.

### CROSS-REFERENCES TO RELATED APPLICATIONS

The present application claims benefit under 35 USC 119(e) of U.S. Provisional Application No. 61/220,973, filed on Jun. 26, 2009 by Soto et al. and entitled “Page Peel,” and U.S. Provisional Application No. 61/220,976, filed on Jun. 26, 2009 by Soto et al. and entitled “Dialog Advertising,” of which the entire disclosure of each is incorporated herein by reference for all purposes. The present application is also related to U.S. patent application Ser. No. ______ (Attorney Docket Number 028009-000110US, filed concurrently herewith by Soto et al. and entitled “Viral Store Application” which is also incorporated herein by reference in its entirety for all purposes.

### BACKGROUND

Embodiments of the present invention relate generally to methods and systems for e-commerce and more particularly to an interactive media player providing e-commerce functions.

On the Internet, one traditional method of promoting a product on a media player platform is through the use of lower third web banner ads. One of the purposes of a web banner is to get the user to click on the advertisement to take the user to another website in hopes of driving a sale.

Typically, a set fee compensates the host of the lower third web banner for every click that leads the user to the advertiser's web site. It is generally accepted that the more users a host has visiting the host's site, the more valuable the host's site is to advertisers. Hosting a lower third web advertisement that sends users to another site can work against the purpose of collecting web traffic. Additionally, not only does a web banner ad force a host to take the risk of losing their web site traffic, but an advertiser also takes the risk of paying for a web banner click that may not generate a sale. Furthermore, users have been becoming less likely to trust a lower third web banner ad that will take the user to an unfamiliar web site.

Merchants have also employed numerous methods to gather market information from consumers. Two methods of gathering market information are through the use of web site polls and surveys. Jus as with web banner ads, users are also beginning to become less likely to take part in a poll or survey that will take the user to an unfamiliar web site. Furthermore, when the user agrees to take a survey on a lower third web banner ad, the user is shipped to another web site. The media content that was playing in the media player also stops or is taken off of the screen. In addition, users often have no incentive to take part in a long survey.

In consideration of the above, it would be desirable for an advertiser to have a method of media player advertising and a method of gathering market information that allows a consumer to stay on the current website and make a secure purchase through a lower third advertisement. Such a method would have benefits for all parties. A consumer can make a purchase from a trusted location that the consumer is comfortable with. Additionally, the consumer's media content is not interrupted. Consumers that take part in a survey can also have the ability to have store credit added to their account upon completion of a survey. Advertisers may see various benefits as well. An advertiser may generate more sales thanks to the greater potential of an impulse buy. Furthermore, the advertiser does not need to use a pay-per-click advertising payment model; instead, a portion of each sale generated from an advertisement can be used as payment to the advertising host. The dialogue ad host also gets to keep the host's web traffic without linking users to another site.

### BRIEF SUMMARY

Embodiments of the invention provide systems and methods for providing an interactive media player with e-commerce functions. According to one embodiment, a method of providing an interactive media player can comprise generating and displaying with a commerce management server a media player including content area, the content area adapted to display a selected content. The media player can also include a content library of available content, and a favorites area of the media player based on a user of the media player. An indication of the selected content can be received and the selected content can be played in the content area of the media player. An interactive ad can be selected based on the selected content and displayed in a lower third banner of the content area during playout of the selected content.

For example, the interactive ad can comprise a voting poll ad. In such cases, a vote selection can be received and results for the voting poll presented through the lower third banner. In other examples, the interactive ad can comprise a survey ad, a multiple choice question ad, a written response questions, or a buy ad. In case of a buy ad, a purchase can be initiated from the media player without causing the user to leaver the media player or stopping playout of the selected content. For example, initiating the purchase is based on a user selection of a portion of the content area including a tagged product.

According to another embodiment, a system can comprise a processor and a memory communicatively coupled with and readable by the processor. The memory can have stored therein a series of instructions which, when executed by the processor, cause the processor to providing an interactive media player by generating a media player including content area, the content area adapted to display a selected content, a content library of available content, and a favorites area of the media player based on a user of the media player. An indication of the selected content can be received and the selected content can be played in the content area of the media player. An interactive ad can be selected based on the selected content and displayed in a lower third banner of the content area during playout of the selected content.

According to yet another embodiment, a machine-readable medium can have stored thereon a series of instructions which, when executed by a processor, cause the processor to provide an interactive media player by generating and displaying with a commerce management server a media player including content area, the content area adapted to display a selected content. The media player can also include a content library of available content, and a favorites area of the media player based on a user of the media player. An indication of the selected content can be received and the selected content can be played in the content area of the media player. An interactive ad can be selected based on the selected content and displayed in a lower third banner of the content area during playout of the selected content.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 shows a basic initial media player layout for a web page and-or email format according to various embodiments.

FIG. 4 shows an example of a voting poll ad type for a web page and-or email format according to various embodiments.

FIG. 5 shows an example of a voting step of a voting poll ad type for a web page and-or email format according to various embodiments.

FIG. 6 shows an example of a poll results step of a voting poll ad type for a web page and-or email format according to various embodiments.

FIG. 7 shows an example of a survey ad type for a web page and-or email format according to various embodiments.

FIG. 8 shows an example of a multiple choice question on a survey ad type for a web page and-or email format according to various embodiments.

FIG. 9 shows an example of a written response question on a survey ad type for a web page and-or email format according to various embodiments.

FIG. 10 shows an example of a buy ad type for a web page and-or email format according to various embodiments.

FIG. 11 illustrates an example of tagging a product within a video for a web page and-or email format according to one embodiment.

FIG. 12 shows an example of the favorites view layout configuration for a web page and-or email format according to various embodiments.

FIG. 13 shows the animation movement of a page peel when the user clicks on it according to various embodiments.

FIG. 14 shows an example of the look of the page peel icon when the icon is initially loaded onto a web page according to various embodiments.

FIG. 15 shows the possible positioning of a page peel icon on a web page according to various embodiments.

FIG. 16 shows an example screenshot of an expanded page peel ad according to various embodiments.

FIG. 17 is block diagram showing various system components that can be used to implement to various embodiments of the present invention.

FIG. 18 is a flowchart illustrating an exemplary process for providing an interactive media player according to one embodiment of the present invention.

FIG. 19 is a screenshot illustrating an exemplary interface for a directions function for a mobile format according to one embodiment of the present invention.

FIG. 20 is a screenshot illustrating an exemplary interface for a map function expanded in full view for a mobile format according to one embodiment of the present invention.

FIG. 21 is a screenshot illustrating an exemplary interface for a hold product function for a mobile format according to one embodiment of the present invention.

FIG. 22 is a screenshot illustrating an exemplary interface for a hold confirm feature for a mobile format according to one embodiment of the present invention.

FIG. 23 is a screenshot illustrating an exemplary interface for a price comparison function for a mobile format according to one embodiment of the present invention.

FIG. 24 is a screenshot illustrating an exemplary interface for a price comparison function for a mobile format according to one embodiment of the present invention.

FIG. 25 is a screenshot illustrating an exemplary interface for a reviews function for a mobile format according to one embodiment of the present invention.

FIG. 26 is a screenshot illustrating an exemplary interface for a reviews function for a mobile format according to one embodiment of the present invention.

FIG. 27 is a screenshot illustrating an exemplary interface for a product page for a mobile format according to one embodiment of the present invention.

FIG. 28 is a screenshot illustrating an exemplary interface for a page peel effect for a mobile format according to one embodiment of the present invention.

FIG. 29 is a screenshot illustrating an exemplary interface for a page peel product page for a mobile format according to one embodiment of the present invention.

FIG. 30 is a screenshot illustrating an exemplary interface for a page peel related videos feature for a mobile format according to one embodiment of the present invention.

FIG. 31 is a screenshot illustrating an exemplary interface for a share product function for a mobile format according to one embodiment of the present invention.

FIG. 32 is a screenshot illustrating an exemplary interface for a share video function for a mobile format according to one embodiment of the present invention.

FIG. 33 is a screenshot illustrating an exemplary interface for an edit video function for a mobile format according to one embodiment of the present invention.

FIG. 34 is a screenshot illustrating an exemplary interface for a play video function for a mobile format according to one embodiment of the present invention.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

The present disclosure relates to interactive media players on the Internet, on mobile phones and mobile devices (e.g., iPad, PSP portable game consoles). More specifically, the present disclosure relates to media players that encourage user interactivity through media player advertisements.

According to various embodiments, a dialogue advertising application can generate target-driven ad types and user interactive web banners based on the media content displayed in a media player. A dialogue advertising application allows merchants to advertise their product and generate sales using an interactive media player that also provides a full payment system. The application also allows merchants and advertisers to gather market information through the use of surveys or polls. These features, along with others, can be implemented without interrupting the playback of media content or ending the current session with the media player.

A dialogue advertising application can be setup and managed from a remote market site location. From that location, the application can be distributed to unrelated web sites, social networking sites, and emails across the Internet. In addition to the Internet, the application may be distributed through mobile SMS text messages and mobile applications. In embodiments that have a full payment system included in the media player, dialogue advertising allows users to purchase products directly from the media player without leaving their current location or stopping their video. Furthermore, if a user purchases a product from a hosted dialogue advertising application on a remote site, the web host can gain a cut from the profits of that purchase.

Various embodiments also use other tools that can provide a better user experience for consumers and more configuration options for merchants. The user may have tools that allow them to browse an entire video library directly from the media player. Within the media player library, a user can drag and drop the video content into a favorites list. A user can then save their favorites list and distribute the media player, along with their favorites list, through their own personal web sites. Merchants may have the ability to tag a specific frame and location in a video that contains a product that they sell. When a user drags his or her mouse over the tagged location, the product will appear in the media player as a buy ad. The user then may have the option to buy the product directly from the media player.

According to some embodiments, an application may generate target driven ad types based on media content displayed in a media player. An application may also generate user interactive web banners based on the media content displayed in a media player. A dialogue advertising application can be setup and managed from a remote market site location. A dialogue advertising application may consist of at least two parts: a media player and an interactive web banner. The media player may allow the display of video content and interactive media. The application may allow a merchant to sell their product using a web banner. The application may allow the user to purchase the product directly from the banner itself Web advertisements may be interactive in order to entice the user to interact with the ad without interrupting the media content currently displayed. Interacting with the ad is done from a single location, and the user does not have to leave the current site the user is viewing.

Various embodiments may use at least three interactive ad types that entice the user to interact with the ad. Ads can be displayed while the media player is playing. A first ad type is the buy ad. A buy ad may allow a user to purchase a product displayed in a web banner directly from the web banner. A second ad type is a survey ad. A survey ad may allow a user to interact with a web banner by taking part in an interactive survey while media plays in a media player. A third ad type is a voting poll. A voting poll may allow users to take part in an interactive voting poll. The results of the voting poll can be displayed after the user votes.

According to various embodiments, a system is disclosed that connects targeted media (e.g., video, interactive media) to a specific web banner ad. Targeting media allows merchants and media advertisers to upload a specific video and display a specific web banner when that video is displayed.

According to various embodiments, a media application is disclosed that connects a merchant's product inventory to the media player. This component helps to allow a user to purchase a merchant's product directly from the media player.

According to various embodiments, a media application is disclosed that connects a merchant's web store to the media player. A merchant's web store is directly connected to the merchant's web store on a market site. After a product is modified on the market site web store, the product can be automatically updated on the dialogue advertising app web store. This component helps to allow a user to purchase a merchant's product directly from the media player.

According to various embodiments, a contained universal shopping cart system connected to a media application is disclosed. A universal shopping cart can allow a user to add an advertised product to a shopping cart where the product awaits checkout. A universal system can further allow a user to maintain items in the user's shopping cart while the user visits a market site connected to the system or dialogue advertising application on another web site.

According to various embodiments, a secure checkout system within a media player is disclosed. A secure checkout system allows a user to checkout an advertised product directly from the buy ad web banner displayed on the media player. A user has the ability to provide their billing, shipping, contact, and credit card info within the media player. This can be done without leaving the current web site location and linking to another site.

According to various embodiments, a secure payment system that communicates with a market site and a media player on an unrelated remote site is disclosed. A secure payment system can facilitate a secure transaction between a merchant and a customer. A payment system can have the ability to operate directly from the buy ad web banner displayed in the media player, without leaving the current web site or linking to another web site.

According to various embodiments, the profits made from a dialogue advertising application transaction can be shared between the market site, merchant, and dialogue advertising app host. As an incentive for hosts of dialogue advertising applications on web sites, a dialogue advertising host may take part in an associate program. An associate program allows a dialogue advertising host to receive a cut of the profit made from the sales gathered from the host's dialogue advertising application. A dialogue advertising application can send a transaction to the market site. After the product is delivered to the customer in good condition, the profits of that sale can be split between the market site, merchant, and dialogue advertising host.

According to various embodiments, an incentive program can encourage users to take part in a survey ad type by awarding users a set amount of store credit upon completion of a survey. Advertisers can have the ability to set a specific amount of store credits that can be given to users that participate in their survey. The survey can be taken without interrupting currently displayed media content. Once the user finishes a survey, store credit can be transferred to their market site account.

According to various embodiments, a management tool is disclosed that allows a merchant to grant or deny the use of the merchant's uploaded media or dialogue advertising ad on specific URL locations or from specific host accounts. Potential dialogue ad application hosts that wish to install a dialogue ad application on a URL may be required to register with a market site and provide their web site demographic information. Before a potential host is granted access to the embed code associated with a dialogue ad application, the potential host can provide the exact URL address where the dialogue ad will be installed and take part in a survey that narrows down their web site demographic. The URLs of hosts can be listed inside a merchant's dialogue advertising distribution list. At any time, if a merchant feels that the URL hosting uploaded media or dialogue advertising ads should not be associated with the merchant, the merchant may disable that URL from displaying their uploaded media or dialogue advertising ad. In addition, any URLs listed by a merchant or market site that have been marked as not acceptable will not be able to display the merchant's uploaded media or dialogue advertising ad. In addition, any site that does not match the merchant's provided demographic will not be able to display the merchant's uploaded media or dialogue advertising ad. A dialogue ad application can be configured to not load inside a URL that is not registered by the merchant or market site.

According to some embodiments, a live chat customer support system that helps dialogue ad users connect with a customer support correspondent provided by either the market site or merchant is disclosed. Live chat customer support can be used to aid a user in any customer support issue related to the dialogue advertisement web store or product. This feature can be implemented directly within a dialogue ad. The user is not required to leave the current web site location and is not necessarily linked to another location.

According to some embodiments, a method of distributing a dialogue advertising application on various web sites is disclosed. Web sites may have the ability to install a dialogue ad application system by registering with a market site. When a web site administrator is finished with the registration process, the administrator can be given various options to install the dialogue ad application onto their own web sites and begin to take part in the dialogue ad associate program.

According to some embodiments, a feature that allows the tagging of an on screen product on a video is disclosed. If a video displays a merchant's product or a product similar to their product, the merchant may have the ability to tag specific frames and/or specific locations within a frame of the video. When a user selects a tagged location, a user is able to click on the location and load a specific product as a buy ad.

According to some embodiments, a video favorites tool that allows users to drag and drop their favorite videos into their own favorites list and that can be distributed onto their own sites is disclosed. Various additional details of embodiments of the present invention will be described below with reference to the figures.

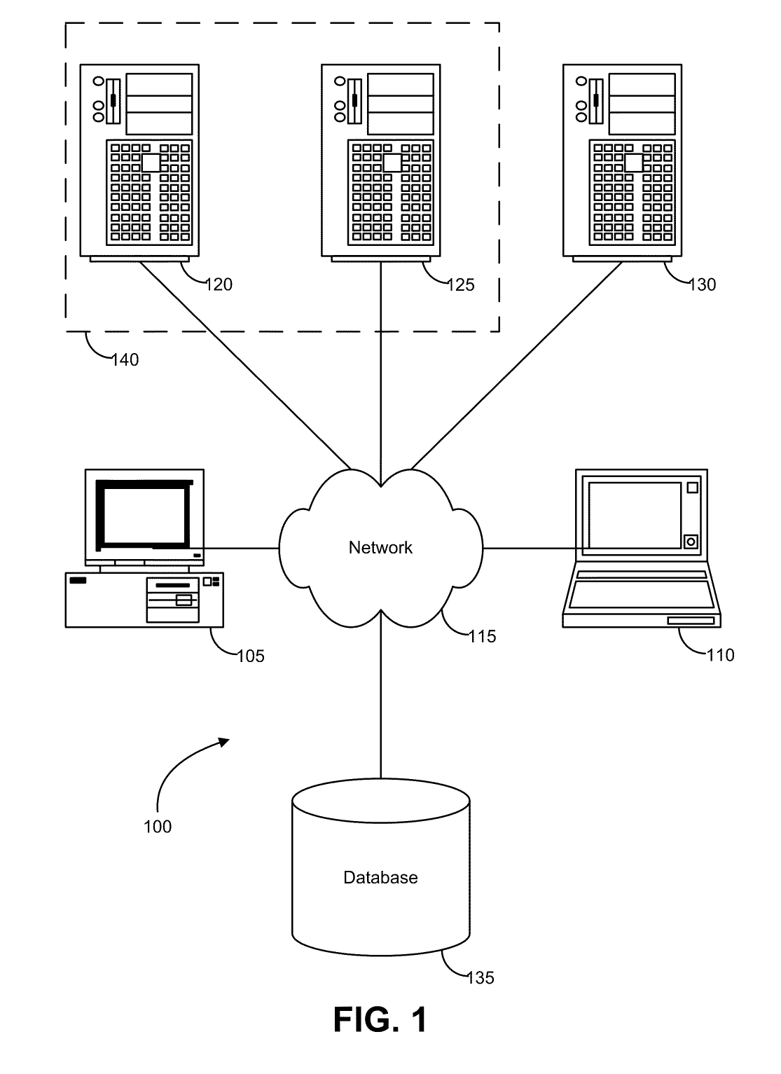

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

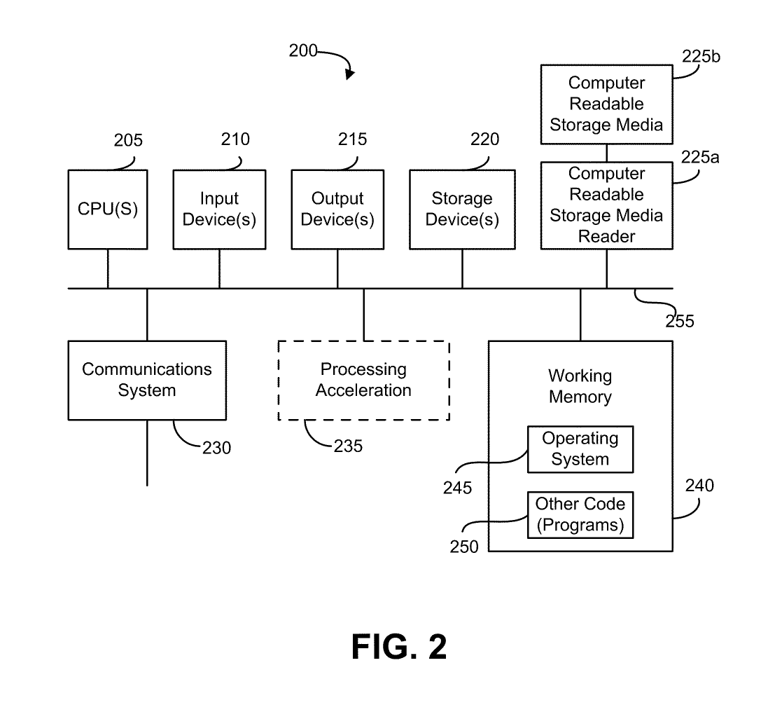

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

Embodiments of dialogue advertisements and their associated systems and methods will be described in detail below. At a high level, various embodiments enable a number of beneficial features for web hosts, merchants, market sites, and consumers. A dialogue ad is an advertisement that is displayed in conjunction with a media player and can act as an embedded web store hosted on a web site. A dialogue ad can allow a visitor of the web site to not only view the products advertised in the dialogue ad, but also purchase the advertised items without having to leave the underlying web site or interrupt media playing in a media player. A dialogue ad can also be linked to inventory data from either a market site, a merchant, or other source. Furthermore, additional features, such as favorites lists, survey ads, poll ads, can also be enabled. Additionally, the content of videos can be linked with the advertisements in a variety of ways. These features and various other features will be described in more detail below.

Various embodiments of dialogue advertising can merge interactive purchasing and market research gathering into a web video media. Dialogue advertising can allow users to make a complete purchase and interact with a video displayed through a media player widget. As a video plays, a targeted sponsor driven advertisement banner can display in the lower third section of the viewable media area. A user may click on an advertisement banner without interrupting content, and interact with the advertisement using at least three different dialogue advertising types: purchasing, survey, and linking. In other words, the user is able to interact with the advertisement while maintaining a session with the media player and/or the host site.

In dialogue advertising, a purchase feature may allow a user to make a purchase without interrupting content displayed in a media player. The buy ad type can be made up of three parts: a lower third web banner, a web store panel, and a checkout panel.

A lower third web banner is typically the actual advertisement banner displayed on the lower third section of a viewable media. Clicking on an advertisement banner can load a web store and checkout panel. Advertisement banners can be a static image or an interactive animation.

A web store panel can be where an advertised product is sold. This area will can made up of a product image, product name, product category, price, product options, quantity, and multiple product views:

A product image can be a selected image view of the product. Clicking on this image may bring up a pop up window that will reveal a scaled view of the image. A user can select the product image by clicking on one of the multiple view thumbnails.

A product name is the name of the product. Quantity refers to the quantity of a product that a use may want to add to a shopping cart.

A product category cab be the category of the product (e.g., watches, hats, shoes, etc.)

Price can refer to the base price of a product before shipping and tax are added.

Product options can refer to a series of specific options for a product. If product options are provided, users may specify various product options before adding it to their shopping cart (e.g., size, color, etc.).

A view thumbnails option can refer to a series of thumbnail images reserved for multiple views of a product. When a user clicks on a thumbnail, a thumbnail may load into the product image. There may be a maximum number of thumbnails that can be associated with a product.

A checkout panel can be where a user makes a complete checkout purchase. A checkout purchase can consist of five steps: payment type, billing info, shipping info, contact info, and purchase confirmation.

During a payment type step, a user may select the type of payment that the user wishes to use to complete a purchase. (e.g., Pay Pal, credit, store credits, etc.)

During a billing info step, a user may fill out the user's billing address and info.

During a shipping info step, a user may select the user's shipping type (e.g., UPS, Fed Ex, USPS, etc.). The user may also give the user's shipping address.

During the contact info step, a user may provide the user's name, email, and phone number. Other information may also be provided.

During a purchase confirmation step, a user may review an order. A user may be able to view items in a cart, billing info, shipping info, contact info, and total amount. If everything is okay, a user may click on a make purchase button to finalize the order. A confirmation email can be sent to the user and the order invoice can be sent to the merchant.

According to some embodiments, the user can gain access to a universal shopping cart feature when a user logs into the user's market site member account. This feature can allow a user to share a common shopping cart with other market sites and dialogue advertisements on other web hosts. If a user adds a product to a shopping cart through a media player and then visits a market site, the added product can be in the market site shopping cart. Any changes made to the market site shopping cart can be updated on the media player shopping cart and vice versa.

A survey ad type can allow a user to take part in an interactive survey provided by a sponsor: A survey ad type banner can be made up of a series of questions provided by a sponsor. Clicking on an advertisement banner can activate the survey without interrupting content playing in the viewing area. Once activated, a user may be able to take part in the survey. A survey can be made up of true/false questions, multiple choice questions, written response questions, and/or other types of questions. Results submitted by the user can be sent to the advertiser and market site.

A sponsor of a survey may have the ability to pay its survey takers through store credit. For a user to take advantage of this feature, the user will typically be logged into their market site member account. Once a user completes the survey, the allotted store credits can be transferred to the user's member account. A user may use the store credit to pay for a purchase. The sponsor sets the amount they want to pay for each completed survey.

A voting poll ad type can allow a user to take part in an interactive voting poll provided by the sponsor. A voting poll ad type can be made up of one question. The system can accept a response and calculate live results to display to users. A user may place a vote that will add a submission to the overall results. Once a user places a vote, the results can be displayed. This can be done without stopping the video or leaving the media player.

A user may have the ability to embed a media player on multiple web platforms. Such platforms may include personal web sites and/or social networking sites. (e.g., MySpace, Facebook). A user may need to register the URL of the page that the media player is hosted on. After a user is registered, the user can be given the embed code that allows the user to install the media player on the user's page.

A favorites panel can allow a user to create a favorites list of media. The media can be dragged and dropped from a media library. A user's favorites list can be saved. A user can take a copy of the media player with their saved favorites list and embed it on their own personal web pages.

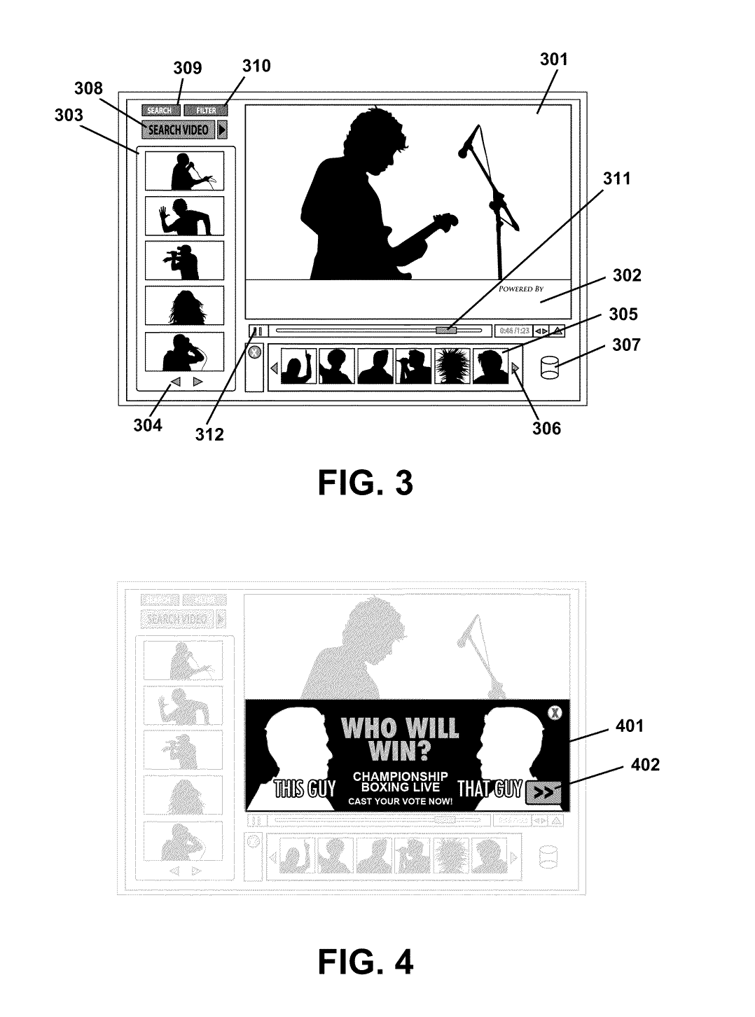

FIG. 3 illustrates a basic layout of the initial media player layout according to one embodiment. FIG. 3 illustrates a “Full View” layout of a media player. A full view allows the user to view the media player with the favorites panel and library panel. There are at least two other view layouts for the media player besides this example. For example, a “Full Screen” and “Favorites View” can be other view layouts. More specifically, a viewable media area 301 is shown. This area 301 displays the selected media content whether it is a video or video game. An area 302 that can display lower third web banner ad types is displayed.

An area that displays the media library content 303 is shown. A user has the ability to browse the media library in thumbnail form through this panel. Shuffle buttons 304 are shown that allow users to shuffle through the media library. A user can search the media library by typing in a tag name in the search text box 308. Search results can be shown as thumbnails inside the media library content panel 303. A search tab 309 is shown that can switch the media library tools to the search tool 308. A filter tab 310 is shown that can switch the media library tools (308) to the filter options.

An area that displays a favorites panel 305 is shown. A favorites panel 305 can be where a user can drag and drop videos from a media library 303. Videos in the favorites panel 305 can be saved to the user's account. A user can distribute the media player with their favorites panel onto their own personal web sites. Clicking on one of the favorite videos will play the video in the viewable media Area 301. Shuffle buttons 306 are shown on the left and the right of the favorites panel. Clicking on the buttons allows a user to shuffle through the favorites video. A user can drag and drop videos from their favorites panel into the garbage can 307 to delete them. A scroll bar 311 is shown that allows a user to scroll through the time code of a video playing in the viewable media area 301. A pause button 312 is also shown that pauses the video currently playing in the viewable media area 301.

FIG. 4 shows the layout and design of a voting poll ad type according to one embodiment. A poll ad type can allow a user to take part in a poll where the user can vote on various subjects set by an advertiser or merchant. Advertisements can be displayed according to matching categories, tag names, and genres with the currently displayed media. A voting poll ad 401 is displayed in the form of a lower third web banner. It is positioned on the lower third portion of the viewable media area 301. As the media is displayed, a voting poll ad can move up into position from below the viewable media area 301. A next button 402 is also shown that can allow users to proceed to the voting step of the voting poll ad.

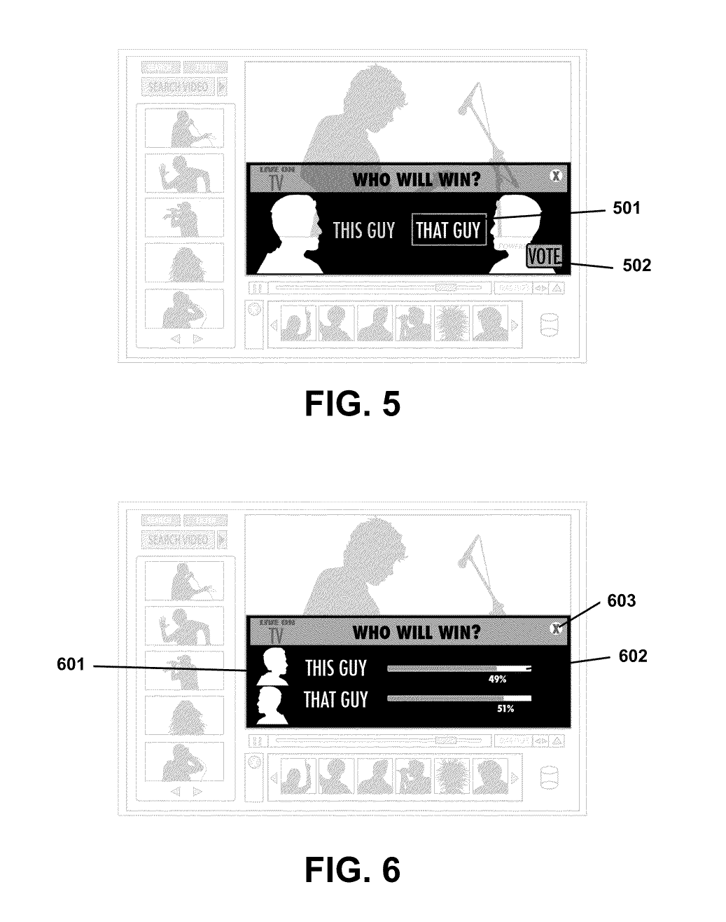

FIG. 5 shows the layout and design of a voting step in the voting poll ad according to one embodiment. In this step a user may be asked to cast a vote. An advertiser or merchant can set multiple answers that a user can select. A user can select a voting option 501. The selected option 501 can be highlighted. A vote button 502 that can cast a user's vote is displayed. Once a vote is cast, the results of the poll can be displayed as illustrated in FIG. 6.

FIG. 6 shows the layout of the poll results according to one embodiment. Once a user casts a vote, a user can be taken to the poll results layout. Voting poll types can be different from a survey ad type because a voting poll may display the results at the end of the poll. Voting poll choices 601 are displayed. Results 602 are also displayed. It can show the percentage of users that voted for each choice. A user can click on a close button 603 to close the web banner.

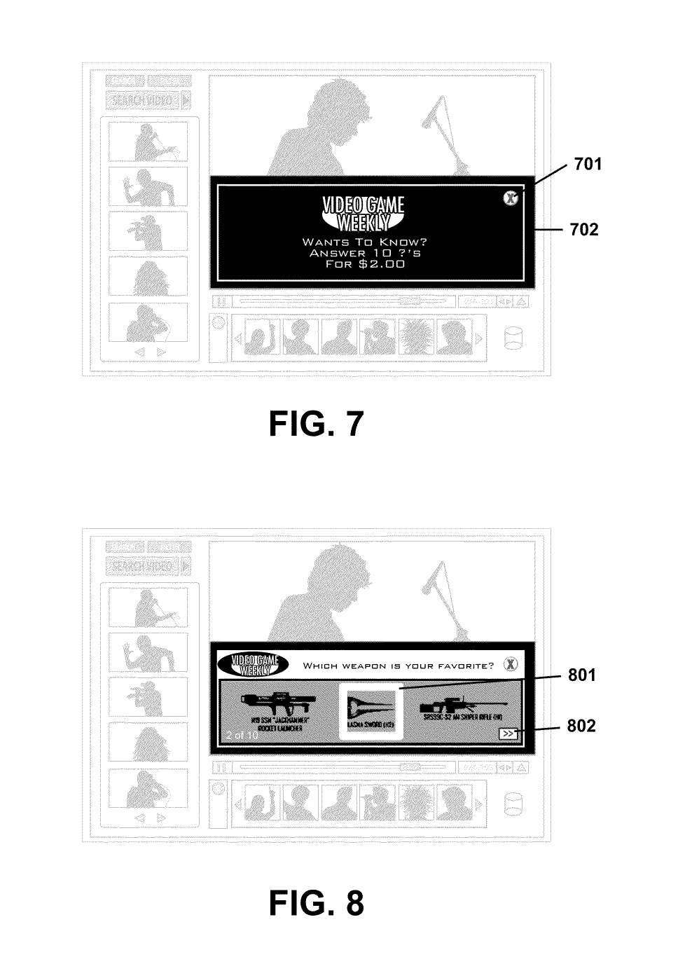

FIG. 7 shows the layout of a survey ad type according to one embodiment. A survey ad type allows users to participate in a survey while watching a video. Merchants and advertisers can set up a survey with multiple questions and incentivize users to respond by giving users a set amount of store credit upon completion of the survey. Surveys can also be linked to display when a specific video, media category or media genre is playing in the viewable media area. The survey ad type can also be adapted to be a quiz. If a user answers all the quiz questions correctly, they can be awarded store credit. An initial survey ad 702 is represented as a lower third web banner that displays on the lower third portion of the viewable media area. To participate in the survey, a user can to click any where on the banner. Once clicked, the user is taken to the first question in the survey. A close button 701 is shown that closes the survey ad.

FIG. 8 shows how a multiple-choice question in a survey ad type is presented according to one embodiment. Figure F displays a multiple-choice question as a visual representation. It is also possible to replace the visual images as text only. A user can select a multiple-choice answer by clicking on one of the images 801. The multiple-choice answer 801 can be highlighted when selected. A user can click on a next button 802 after the user selects an answer. A user can click on the next button to submit an answer and proceed to the next question.

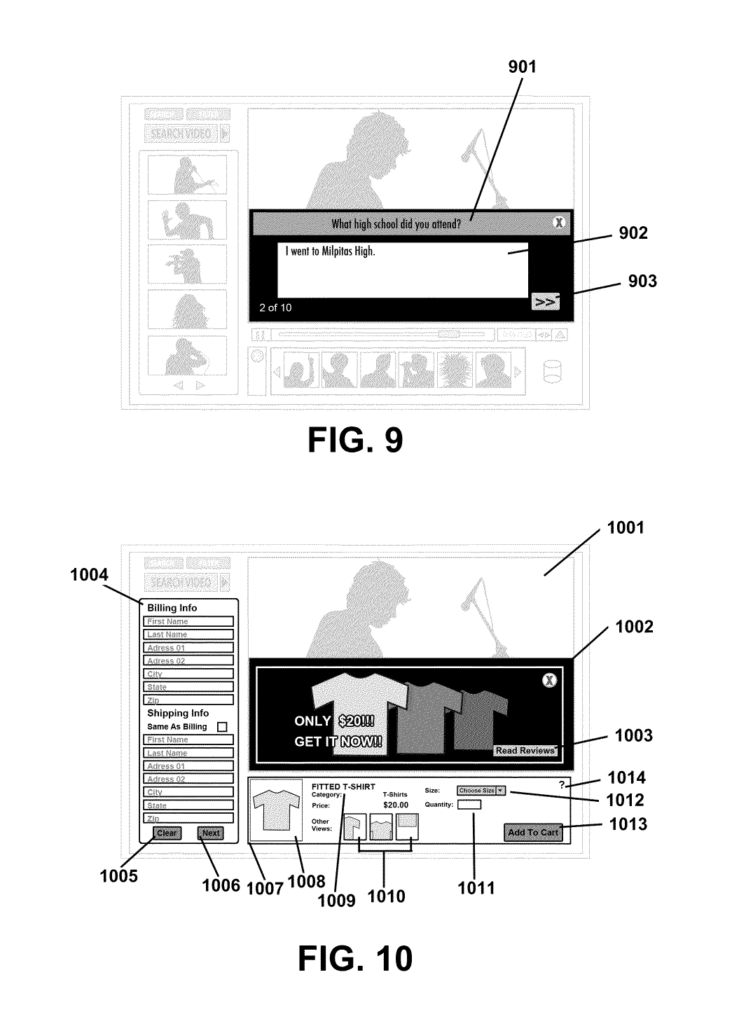

FIG. 9 shows how a written response question in a survey ad type is presented according to one embodiment. In a written response survey question, the user is may answer a question as a written response. An area is shown where the survey question 901 is displayed. An area is also shown where a user can type in a written response 902 to the survey question. A next button 903 can be clicked after the user is finished writing a response. The next button 903 can submit a user's answer and proceed to the next question.

FIG. 10 shows the layout and design of a buy ad type according to one embodiment. This ad type can allow users to purchase an advertised product directly from the media player without stopping the currently displayed video. Merchants can connect their product inventory and market site web store to a buy ad. Purchases made from a buy ad can communicate directly with a merchant and a market site. A web site that hosts the buy ads may receive a cut of the profits from purchases made from their hosted location.

Buy ads 1001 can be displayed with the currently playing video. A buy ad 1001 can be displayed according to a specific video, tag name, category, or genre. For example, if a currently playing video shows a person playing a guitar, the buy ad 1001 that displays can be of a guitar. A merchant that is selling their product on a market site can create buy ads. A buy ad 1002 can be displayed as a lower third web banner that is located on the lower third section of the viewable media area 301.

A user can click the read reviews button 1003 of the buy ad 1002 to view the reviews for an advertised product. Reviews can be directly piped in from the market site reviews and can be updated automatically.

A web store panel 1007 can be displayed that allows a user to view basic information about the product advertised and allows a user to select product options for the product. Product options may include selecting options such as size, color, quantity, etc. For example, a product image 1008 can be displayed. A selected product view 1010 may dictate the image displayed in the product image spot. At 1009, the product options area displays the products name, category, and base price. Product options can be a direct representation of the product options on the market site. When market site product options are modified, the product options can be automatically updated in the dialogue ad. Multiple product views 1010 can be displayed in thumbnail form in the other views section. Selecting a product view thumbnail may load the image into the product image 1008.

The user can enter the quantity 1011 of the selected product that the user wants to purchase. A user can select specific options from a drop down list 1012 if the merchant's product has options to choose from (e.g., size, color, etc.). An add to cart button 1013 is displayed that can add a product with selected options into a user's universal shopping cart. Clicking on the Help Button 1014 opens a window that allows the user to connect with customer support using the live customer support chat feature.

A user can complete a checkout by providing billing, shipping, contact, and credit card information in the checkout panel 1004. A clear button 1005 is displayed that can clear the information entered in the checkout panel. At, a next button 1006 is displayed. A user may click on the next button 1006 to proceed to the next step and submit information.

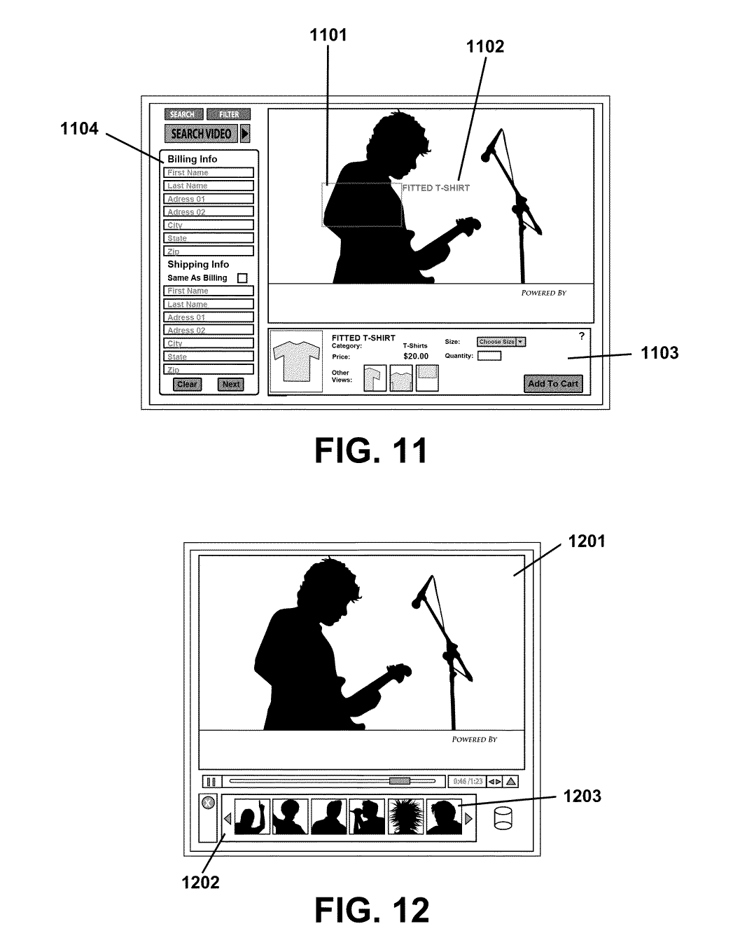

FIG. 11 shows how a merchant whose merchandise is shown in some point of the video can tag a video with their product according to one embodiment. Tagging a video in a specific location allows a merchant to connect a product for sale on the market site to a product viewed in the video media player. Users are able to purchase products shown in the video directly from the media player. A video frame 1101 is shown that has been tagged with have a square box around a location 1102. The box may only appear when a user hovers the user's mouse over it. The box may indicate that the product is available for sale. Clicking on the box can load the products web store in the media player. Here, a tagged video frame location 1102 is shown that also displays the product's name. In this example, a tagged video product that loads the products web store information 1103 is shown. Selecting a tagged video product can also load a checkout panel 1104 as shown.

FIG. 12 shows a favorites view layout configuration according to one embodiment. This configuration can be used for users who embed the media player on their own personal web pages with a copy of their favorites list. Favorites lists can be created when a user drags and drops videos from a media library 303 and into the favorites list panel 305. A viewable media area 1201 of the favorites view layout is shown. A user's favorites panel 1202 is also shown. The panel can hold the favorite media that a user has selected. Media can be dragged and dropped into this panel from the media library. Media is represented in thumbnail 1203 form. Clicking on a thumbnail can load media and play it inside the viewable media area.

It should be understood that the user interfaces illustrated in the attached figures and described here are provided for illustrative purposes only and should not be considered limiting the various embodiments of the present invention. Rather, it is contemplated that such interfaces may vary significantly in format, content, layout, etc. depending upon the exact implementation of particular embodiments. These variations are considered to be within the scope of the present invention. For example, in some cases, the media player may be presented in a web page as part of or accessible through a page peel advertisement. Embodiments of page peel advertisements and their associated systems and methods will be described in detail below. At a high level, various embodiments enable a number of beneficial features for web hosts, merchants, market sites, and consumers. A page peel ad can act as an embedded web store hosted on a web site. A page peel ad can allow a visitor of the web site to not only view the products advertised in the page peel ad, but also purchase the advertised items without having to leave the underlying web site. In other words, the user is able to interact with the advertisement while maintaining a session with the host site. A page peel ad can also be linked to inventory data from either a market site, a merchant, or other source.

Various features may make up a page peel ad. Some of those features may include: Page Peel Design and Animation, Advertisement, Modified Web Store, Payment Gateway, and associate program.

A page peel ad may be presented and designed as an animated peeling advertisement. When the user clicks on the page peel icon, the page peel animation can be activated. The page peel icon may peel back to reveal the advertisement. On the fold of the peel is the web store and checkout for the product being advertised.

A page peel ad may provide a method to creatively advertise a product and enable the user to purchase the product directly from the advertisement. When a merchant creates a page peel ad campaign on a market site, they can create an advertisement to represent their product on the page peel ad. The advertisement can be in different forms, such as: static image, animated, or interactive. A static image displays as a still image that cannot be interacted with. An animated version is an animated image that has moving graphics. An interactive version allows for user interactivity such as clickable objects or a web game.

A web store is a representation of the web store that the merchant creates on the market site. One difference between a web store that appears on a market site and a web store that appears in a page peel ad is that instead of displaying the whole market site web store, a page peel ad may only display the web store portion that represents the product currently being advertised. Because the page peel ad web store can be directly connected to the web store on the market site, when information is updated on the market site, the information will automatically update on the page peel ad. A user is able to view the product information and choose product options like size, color, etc.

A page peel ad can facilitate a live and secure transaction directly from the ad. By facilitating tools and features to make a live transaction from the ad, the user will does not have to leave the current site that they are on. The payment gateway for the page peel ad may include a checkout and a shopping cart option.

The page peel ad associate program allows the web host and advertisers to break from the traditional pay-per-click ad payment system. Instead of paying a web host for every ad click that comes from their site, the page peel ad associate program allows the web host to gain a cut from every product sold from their site. Every time the web host makes a sale from their hosted page peel ad, they can receive a set amount of profits gained from that sale.

There are also other enhancements that can provide a better shopping and advertising experience for the user and advertiser. For example, user enhancements may include a shared universal shopping cart, a cell phone payment method, a product review module, and a live customer support chat module.

A shared universal shopping cart may be implemented for some embodiments. When a user logs into their source site member account through the page peel ad, the user can gain access to the shared universal shopping cart feature. This feature may allow the user to share the same shopping cart, which is displayed through the page peel ad, with other source sites associated with the network of market sites. If the user adds a product to their shopping cart through the page peel ad and visits a source site, the product may be in the source site's shopping cart as well. Any changes made to the source site shopping cart can be updated on the page peel ad shopping cart, and vice versa.

According to some embodiments, the user may be able to use their cell phone number as a payment method. To do this, the user first logs into their source site member account and sets up this feature. From the set up menu, the user can enter their billing, shipping, and credit information. The user can then enter their cell phone number to associate it with the saved information that they previously submitted. Once the phone number is submitted, a confirmation text message may be sent to the given cell phone number for activation. The user can then approve the activation by replying the text message and entering a pass code.

Once the cell phone payment method is set up, the user may choose to enter their cell phone number to pay for the purchase. Every time a purchase is made with the cell phone number, a confirmation text message is sent to the phone number and the user may reply to the text message with the given pass code in order to finalize the order.

According to some embodiments, the user has the ability to access reviews or create a review for a product. When the user selects reviews, the screen may display the reviews most relevant and give the user the option to query the results as they wish. The user may also be able to vote on whether they found the reviews helpful or not.

According to some embodiments, the merchant has the option to assign a designated customer support chat contact to take advantage of the live customer support chat feature. The user can click on the customer support option in the page peel ad to chat with either a market site representative or merchant representative.

An advertiser may be given various tools and features to help create, manage and distribute their page peel ad campaign. Some example tools may include a controlled distribution list, a targeted ad system, and a share component.

A merchant enhancements may include a controlled distribution list. Potential page peel ad hosts may go through a registration step when obtaining their page peel ad embedded code. Page peel ad hosts could provide the exact URL where the page peel ad may be hosted. If a page peel ad host fails to provide a URL, some embodiments may not allow the page peel ad to load at the URL. The page peel ad URL locations can then be compiled into a distribution list. This list allows the merchant to monitor and manage the distribution of their page peel ad on specific URLs. A Merchant may then have the option to block specific URLs listed in the distribution list. URLs blocked by a merchant may not be able to load the page peel ad at the URL.

A targeted ad system may calculate potential matches between the page peel ad campaigns and the web site host URLs. When the merchant creates a page peel ad campaign, they may be required to take a survey that determines their campaign's target audience and demographic. For example, it may not be desirable to advertise pap music CDs on a cooking website. Page peel ad web hosts may also take a survey to determine their target audience and demographic.

A share component can allow a small or a big website owner to use the page peel ad application on their own web pages. Web hosts may be required to create an account and take a survey that determines their demographic. Once the information is collected, web hosts can be given the embed code that allows them to install the application onto their web page. The targeted ad system calculates the best possible ads to display on their page peel ad application.

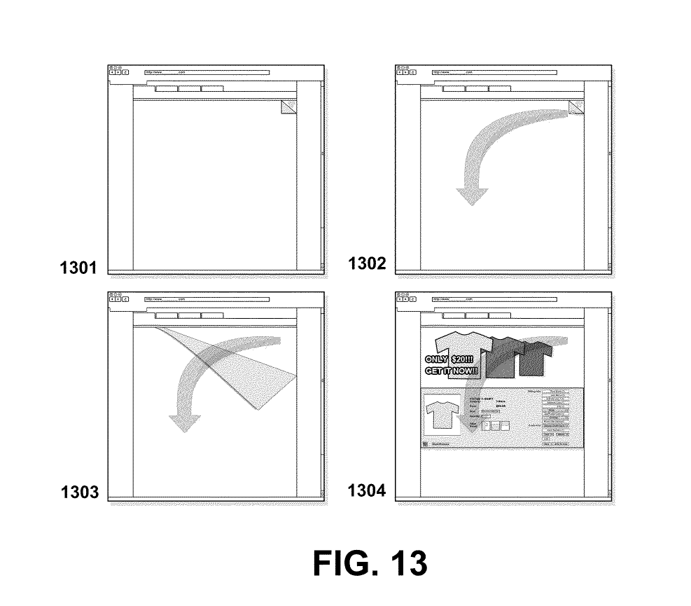

FIG. 13 shows how the user interacts with the page peel ad and displays an example of how it animates when activated according to various embodiments. At 1301, the initial layout of the page peel is in the form of a small page peel icon. The placement of the page peel icon can be positioned in multiple places on the web page. In this example the page peel icon is located on the top right corner of the web page. At 1302, the user clicks on the page peel icon to activate the page peel animation. At 1303, the page peel folds downwards and peels away the front page of the web page. At 1304, once folded down, the page peel ad is revealed above the fold. Below the fold can contain the web store and checkout. When the page peel ad closes it folds back the way it came down.

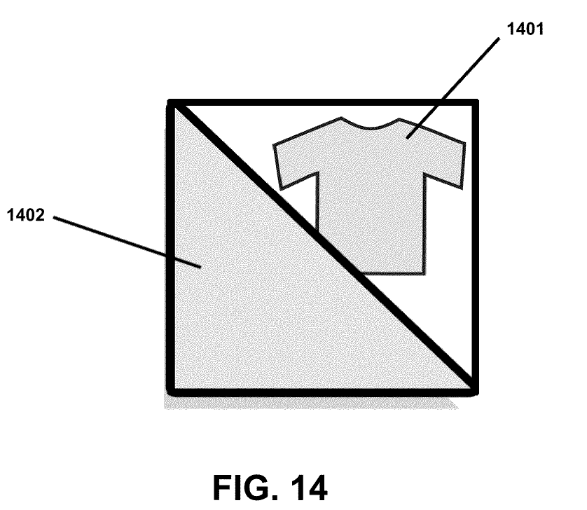

FIG. 14 shows the design and layout of the page peel icon according to various embodiments. The page peel icon is the initial layout of the page peel ad. Clicking on the page peel icon can activate the page peel animation, which ultimately reveals the actual page peel ad. Here, area 1401 illustrates where the actual page peel ad is displayed. In icon form, the page peel ad can be displayed as a smaller version than the actual page peel ad. In area 1402, the top layer of the page peel can be shown. As shown here, it can be designed to look like a folded over piece of paper.

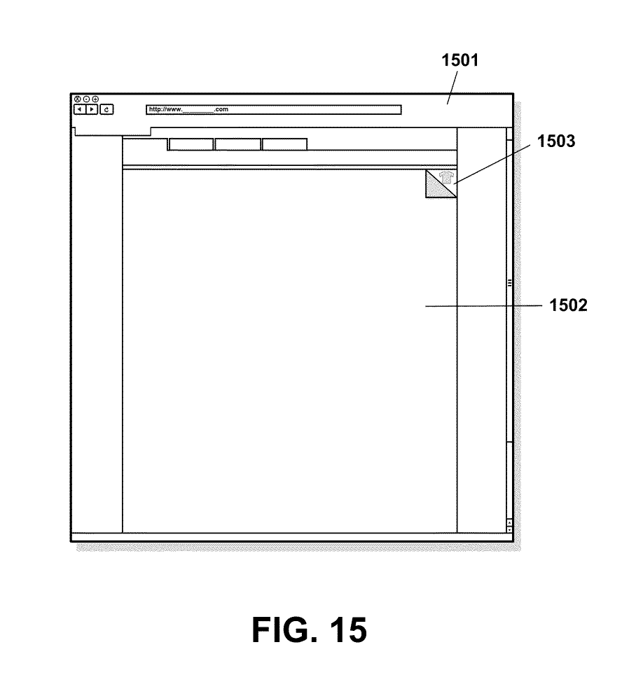

FIG. 15 shows the initial layout and look of the page peel ad placed on a web page according to various embodiments. The initial page peel ad is displayed in icon form. This page peel icon can be positioned in numerous locations and configuration on the web page. In this example the page peel icon is located on the top right hand corner of the web page. More specifically, an example web browser window 1501 is shown. The space 1502 on the web page that the page peel ad will be displayed is shown. The position of the page peel icon 1503 is also shown. It is placed in the top right hand corner of the web page. Other configurations may have the page peel icon in other areas.

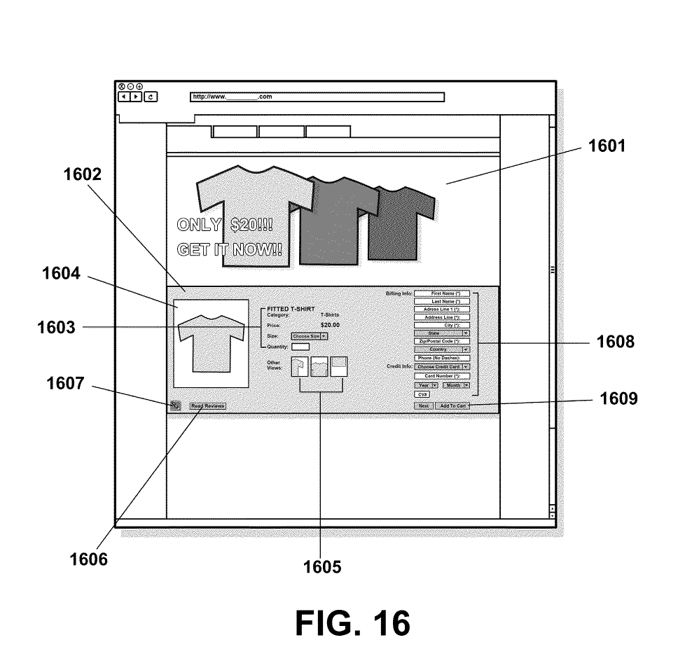

FIG. 16 shows the full layout of the page peel ad when it is activated and expanded according to various embodiments. This is the layout of the page peel ad after the user clicks on the page peel icon. Once the Icon is clicked, the page peel ad animation can be activated. The page peel icon will peel down and folded into layout displayed in this example. The position of the peel on the web page can determine the manner in which the page peel ad animation lays out. The advertisement area 1601 of the page peel ad application is shown. This area can display the actual product being advertised in the page peel ad campaign. The advertisement can either be a static Image, animated image, or interactive image. A static image can load up as a plain image that the user does not interact with. The animated image is an ad that has animated movement in it. An interactive image is an ad that the user can click and interact with (e.g., an ad with clickable properties, an ad in the form of a web game, etc.).

The area 1602 of the page peel ad where the product being advertised can be sold is also shown. This area 1602 can display the web store for the specific product, full checkout system, and functional page peel ad tools. At 1603, the product information and product options tools that are part of the product web store are shown. The area of information can display elements such as: product's Name, product's category, product's base price, product options buttons (e.g., size, color, etc.), and quantity box. When the product information is modified from the market site, the information can automatically update the product information on the page peel ad. The product image 1604 that represents the product being sold from the web store is shown. When the product image 1604 is modified from the market site it can automatically update the product image in the page peel ad. Product views thumbnails 1605 are also shown. Clicking on one of the product views thumbnails 1605 will load the view into the product image area. When product views are modified from the market site it can automatically update the product views thumbnails on the page peel ad. Clicking the product review button 1606 can display the product reviews for this product. The product reviews can be generated directly from the market site. When a review is modified or created from the market site, it can be automatically updated on the page peel ad. The page peel ad tools icon 1607 is shown. Clicking on this icon can open a window that allows the user to close the page peel ad or connect to a customer support representative using the live customers support chat feature. At 1608, the area that displays the checkout and payment system for the page peel ad is shown. Users are able to fill out their billing, shipping, contact, and credit information to make a secure purchase for the product being advertised. Once an order is placed, the order and transaction can be distributed. The Add to Cart button 1609 allows the user to add the product to their universal shopping cart. If the user has a registered account with one of the multiple market sites, they may have the option to add the product to their universal shopping cart. As noted above, the product can remain in their shopping cart when they travel to other market sites or add products from other page peel ad hosted web pages.

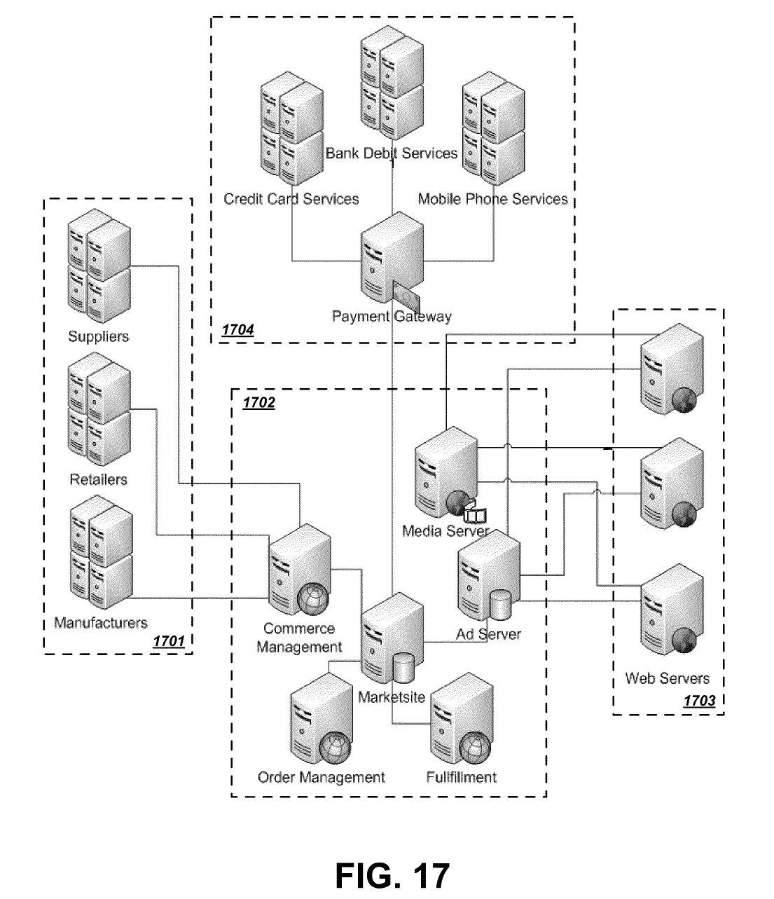

In FIG. 17, various system components that can be used to implement VSAs according to various embodiments are shown. As illustrated here, servers 1701 of various Suppliers, Retailers, and/or Manufacturers scan manage their published inventory via the Commerce Management server 1702. Commerce Management server 1702 can be adapted to provide an application, i.e., a Viral Store Application (VSA) for distributing and promoting product information from the servers 1701 of various Suppliers, Retailers, and/or Manufacturers as described in the Related Application entitled Viral Store Application referenced above and incorporated herein. As described therein, once the inventory is known and the policies on where a VSA instance with inventory has been established with the Commerce Management server 1702, the VSA instances can be distributed to one or more web servers 1703 or other locations or devices e.g., a phone, a smart phone, etc., remote from the Commerce Management server 1703. Any number of instances or a VSA can be distributed. Orders can flow back from the web servers 1703 or other remote devices to Commerce Management server 1702 to trigger order management processes. Orders can also possibly flow from Commerce Management server 1702 to the servers 1701 of the various Suppliers, Retailers, and/or Manufacturers if demand exceeds supply. Orders may also result in a purchase transaction where Commerce Management server 1702 communicates with servers and/or services of one or more payment networks 1704 to initiate a credit card transaction, a bank debit, or add the transaction to the mobile phone bill. In addition to or instead of providing a VSA, the commerce management servers, for example via a media server or other system, can be adapted to provide an interactive media player as described herein.

The media player described herein can be implemented in a number of different ways and may, in some cases, be implemented as an interface to or itself as a VSA as described in the Related Application. As described therein, a VSA can facilitate the management, promotion and sale of products. It allows merchants to gather transactions from customers on separate web pages, emails or cell phone text messages. Embodiments of the VSA may be distributed with product display tools, shopping options, secure checkout capabilities, universal shopping cart, product reviews, price comparison tools, in-store pickup capabilities, sharing tools and store front interfaces. The viral component of the VSA may also allow outside users to duplicate VSA Web Stores and install it on their personal web pages (e.g., MySpace, Facebook, Blogger, a personal web site, etc.). Users may then send emails or SMS messages announcing the VSA to their friends. Copies of the store can have the ability to spread across the Internet an infinite number of times. Orders made from the VSA can get sent back to the merchant. The transactions can be funneled down to a market site where the merchant created their original web store. If a VSA host takes part in the associate program, they may receive a cut from the profits made from their VSA location.

Another aspect of the VSA application may allow users to generate a “most wanted” list of products that the user wishes to receive as gifts. The most wanted list can then be turned into a VSA. The user can host the most wanted VSA list on a personal web page, such as a social networking site. The user may also distribute their VSA list as an email or SMS text message/notification. The user's friends can view the VSA and purchase the products for the user or take part in a collective payment contribution towards the products' purchase.

The VSA comprises an application that facilitates the management, promotion and sale of products on outside hosted platforms (i.e., web sites not owned or managed by the merchants of the products for sale) from a contained application. The application can take inventory information from a market site location and turn it into a web store that allows users to distribute products on their own personal web pages, emails, cell phones, or other means. Copies of the application can be managed and controlled from a single market site or mobile application. The market site can provide merchants with tools to manage their application. This application is often referred to as a VSA or VSA application.

A complete and secure shopping cart checkout is enabled within the VSA. A customer may browse products from a VSA application and add the products to a shopping cart within the VSA. Consumers then may have the ability to complete a secure credit card or other payment method transaction without leaving the web location hosting the VSA.

A shared shopping cart can be implemented that remembers the products added to the cart as the customer travels between the market site and VSAs hosted on other sites, emails or on a mobile application. The shared shopping cart can enable a customer to make one transaction while switching between web stores, VSAs on emails or mobile applications linked to the market site and VSA.

VSAs hosted on various sites communicate with merchants and fulfillment warehouses to maintain up-to-date inventory information. This helps allow orders and transactions to be made from a location other than the market site. When inventory is out of stock on the market site, the VSA location web store can display the product as “Out Of Stock.” When product inventory or product information is updated from the market site, the VSA location web store may be updated at the same time.

The revenue or profit generated from a VSA transaction is shared between the market site, merchant, VSA Host and, in some cases, the fulfillment warehouse. As an incentive to distribute the VSA on personal web pages, emails or cell phones, a VSA Host may take part in an associate program. The associate program allows a VSA Host to receive a cut of profits made from the sales gathered from their VSA location. The VSA application can send the transaction to the market site. Once the product is shown as delivered to the customer in good condition, the profits of that sale can be split between the market site, merchant, VSA Host, and, in some cases, the fulfillment warehouse.

The VSA application can be distributed across the internet and across cell phones or other mobile devices is disclosed. Users are able to notify their friends of a VSA store open for business by email or text message. When the recipient opens the email or text message, they may receive an actual VSA application with the product that the user recommends. The recipient is able to make a complete purchase from their email or text message. If sent as a text message, the viewer cam linked to a VSA via their mobile browser or mobile application. If sent as an email, the user can complete a transaction if the email platform allows. If not allowed, then the user can be linked to the web page of the VSA location.

A VSA can be created from a most wanted list. Users can go to the market site, located on the Internet or mobile application, and choose their favorite products to put into a list connected to their market site account. From their list of Most Wanted Products, the user can create a VSA with the chosen products. The user may then distribute the VSA most wanted list by hosting it on their personal web pages or sending it via email or text message. Friends of the user are able to view the most wanted list and purchase the products for the user. Once the product is purchased, it can be shipped to the user.

A collaborative payment option may allow a group of customers to contribute a portion of a payment towards a purchase. For example, if a user has a most wanted list VSA, the user's friends can contribute funds towards a specific product. Contributions can be made public or anonymously by announcements. Once the product has enough collective funds for payment, the credit cards may be charged and the product can be shipped to the user. However, it should be noted that payment is not limited to credit cards. Other payment types are also available. e.g., phone bill, bank transactions, 3^{rd} party payment systems such as Pay-Pal, etc.

A management tool allows the merchant to grant or deny use of their VSA or product on a VSA. Potential VSA hosts that wish to install a merchant's VSA on a URL can be registered with the merchant and the market site. Before the potential host is granted access to the embed code used to create a VSA, the host may be required to provide the exact URL address where the VSA may be installed. The URL can be listed inside the Merchant's VSA distribution list. If a merchant feels that they do not want to be associated with a specific URL, the merchant may disable the URL. As a result, the VSA may no longer be displayed at the disabled URL. Additionally or alternatively, specific products can also be disabled from being displayed at a URL. In addition, URLs can be blocked during the registration phase. The VSA application can be configured to not load inside a URL that is not registered by the merchant or market site.

A live chat customer support system can be used to help VSA users connect with a customer support correspondent provided by either the market site or merchant. Live chat customer support can be used to aid the user in any customer support issue related to the VSA or product.

Also as described in the Related Application, providing a Virtual Store Application (VSA) can comprise receiving a request at a commerce management server, the request to create a new VSA on a system remote from the commerce management server. Links between the new VSA and product information for each of one or more products stored on one or more servers remote from the commerce management server can be defined. The links between the new VSA and the product information can be stored as a definition for the new VSA. A link to the definition for the new VSA can be inserted into a web page on the system remote from the commerce management server. For example, the web page on the system remote from the commerce management server can comprise a web page selected from a group consisting of, a social networking page, a blog page, personal web page, email, mobile device application. In some cases, inserting the link to the definition of the new VSA can comprise inserting a new element into the web page, the new element comprising an ad having a page peel effect for revealing the VSA.

In some cases, receiving the request to create the new VSA can comprise receiving a request to create a first generation VSA. In such cases, defining the links between the new VSA and the product information can comprise receiving a selection of the one or more products and creating the links to the product information for the selected products. Alternatively, receiving the request to create the new VSA can comprise receiving a request to create multi-generational VSA. In such cases, defining the links between the new VSA and the product information can comprise identifying a source VSA for the new VSA and copying at least one link to product information from the identified source VSA to a link in the new VSA.

The method can further comprise tracking creation of the new VSA. For example, tracking the creation of the new VSA can comprises determining whether the new VSA is a first generation VSA. In response to determining the new VSA is not a first generation VSA, a source VSA for the new VSA can be identified. A link between the source VSA and the new VSA can be identified. A record of the link between the source VSA and the new VSA can then be stored.

Embodiments of the present invention provide a media player that provides for tagging a product within the video. The user can then select the tagged product within the video while the video plays and purchase the selected, tagged product through the video player, for example through a bottom third ad while the video continues to play. According to one embodiment, this purchase process may be supported by or provided through a VSA. When supported by or through a VSA as described in the Related Application, the media player can provide a number of features including but not limited to a price comparison tool, product and video ratings, in-store pickup options, sharing products, sharing videos, video editing tools, related products, related videos.

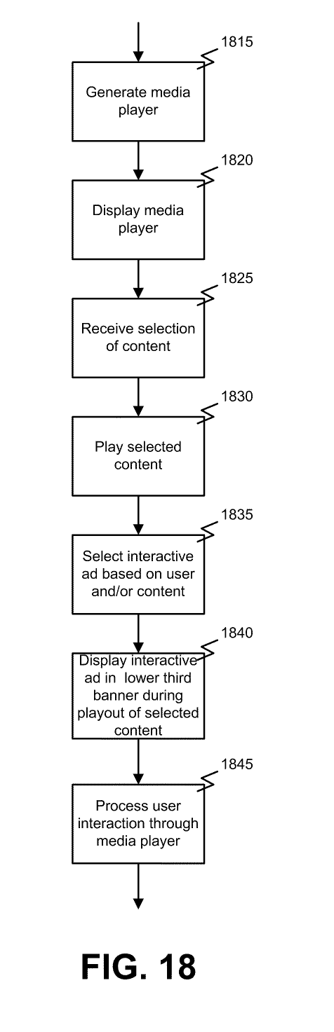

FIG. 18 is a flowchart illustrating an exemplary process for providing an interactive media player according to one embodiment of the present invention. In this example, processing begins with generating 1815 a media player. As described above, the media player can include a content area adapted to display a selected content. The media player can also include a content library of available content, and a favorites area of the media player based on a user of the media player. Once generated, the media player can be displayed 1820.

An indication of the selected content can be received 1825 and the selected content can be played 1830 in the content area of the media player. Additionally, an interactive ad can be selected 1835 based on the selected content and displayed 1840 in a lower third banner of the content area during playout of the selected content. User interaction with the interactive ad can then be handled 1845 without leaving the media player and while continuing playout of the selected content. For example, the interactive ad can comprise a voting poll ad. In such cases, a vote selection can be received and results for the voting poll presented through the lower third banner. In other examples, the interactive ad can comprise a survey ad, a multiple choice question ad, a written response questions, or a buy ad. In case of a buy ad, a purchase can be initiated from the media player without causing the user to leaver the media player or stopping playout of the selected content. For example, initiating the purchase is based on a user selection of a portion of the content area including a tagged product.

Stated another way, embodiments of the present invention provide a media player that provides for tagging a product within the video. The user can then select the tagged product within the video while the video plays and purchase the selected, tagged product through the video player, for example through a bottom third ad while the video continues to play. According to one embodiment, this purchase process may be supported by or provided through a Viral Store Application (VSA) such as described in the Related Application entitled “Viral Store Application” referenced above and incorporated herein. When supported by or through a VSA as described in the Related Application, the media player can provide a number of features including but not limited to a price comparison tool, product and video ratings, in-store pickup options, sharing products, sharing videos, video editing tools, related products, related videos.

For example, clicking on a web site listing through the media player can display the price for the currently selected product as sold by the web site. The URL of the website and listing type (e.g. Website or Retail Location) may also be displayed. Available product options for the product may also be displayed, if the web site provides them. A purchase button allows the user to purchase the product. The web site may or may not be associated with the VSA or market site connected to the VSA. If the web site listing for the product is not associated with the VSA or market site connected to the VSA, then clicking on the purchase button for the product in the media player can link the user to the web page where the product is sold. If the web site is associated with the VSA or market site connected to the VSA, then clicking on the purchase button for the product in the media player can add the product, with the specified product options, to the VSA shopping cart accessible through the media player. Clicking on a retail store listing in the media player can display the price for the currently selected product as sold by the retail store. The name of the retail store and listing type (e.g. Website or Retail Location) may also be displayed. Available product options for the product may also be displayed. The address of the retail store location and phone number may also be given. There are multiple actions that the user may take from this page. Including but not limited to getting directions, requesting a product hold, and requesting a map.

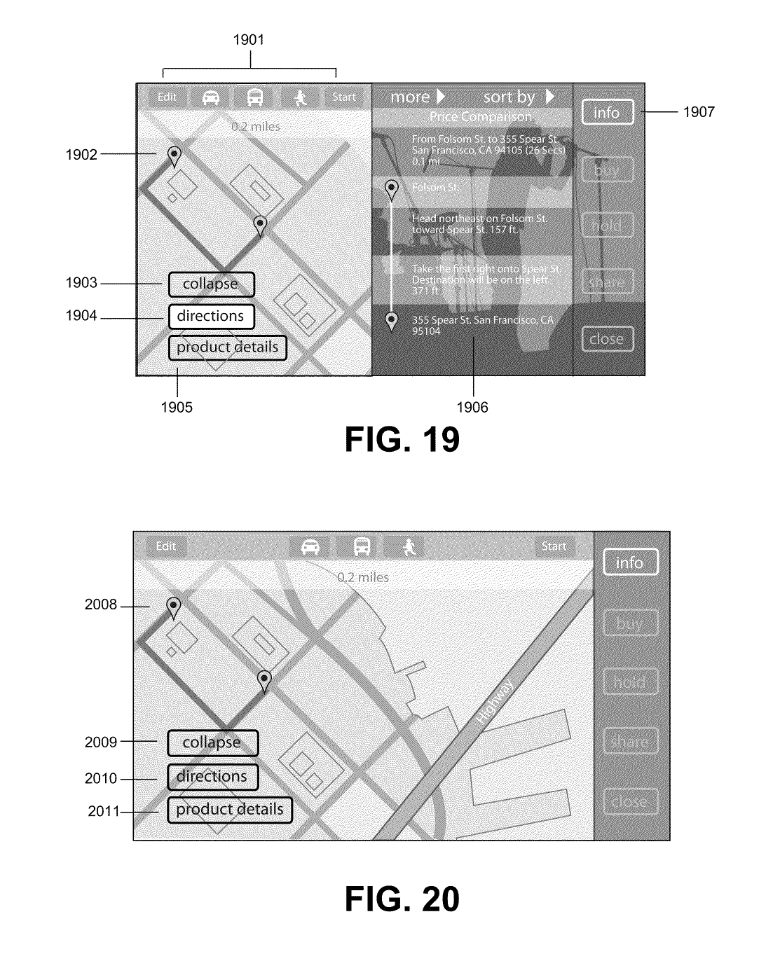

Embodiments of the present invention include different configurations for the media player. One is adapted for implementation on the web, e.g., through social networking sites, blogs, personal web pages, etc. The other adapted for implementation on a mobile phone or other mobile device. An additional configuration can be for other devises like, gaming consoles, televisions, or iPads. These different configuration can have the same set of tools and features. They may however differ with the interaction and layout of the design. That is, a mobile version of the media player may hold the same tools, functions, and features as described for the web version above with reference to FIGS. 3-16 but different in the user interface layout and user interaction based on the device showcasing the media player. Thus exemplary user interfaces for a mobile version of the media player and functions supported thereby will be described below with reference to FIGS. 19-34.

FIG. 19 is a screenshot illustrating an exemplary interface for a directions function for a mobile format according to one embodiment of the present invention. More specifically, this figure illustrates an example of the directions feature for navigating to a selected retail store on a mobile device. For example, clicking on a map button in the media player displays a map from the user's specified starting location to the retail store location. The starting point can be based on the mobile device's GPS location and the retail store location based on a selected product and information for that product maintained by a VSA or other application supporting the media player. In some cases, the address starting point may be provided by the user and displayed. Additionally or alternatively, the user may change the starting address by clicking on the change-starting button. The two points on the map pinpoint the starting location and the retail store location. A trail is outlined, mapping the path between the two locations.

As illustrated in FIG. 19, the map interface of the media player can include different sorting options 1901 for different transportation types. The user may get directions or map for car, public transit, or walking. When a transportation type is selected, the directions and navigation path on the map changes accordingly. A map 1902 displays the location of the specified starting address to the retail store. A pathway is outlined between the two, according to the navigational directions provided. Other user interface buttons allow the user to either expand or collapse 1903 the map. Additionally or alternatively, clicking on the directions button 1904 loads the navigational directions on the right panel. Clicking on the product details button 1905 loads the product page for the currently selected product. The directions feature is located under the info tab 1906 of the mobile media player.

In addition to the map page, multiple options can be available for the user to take action from here. Those actions can include but are not limited to a new starting point, directions, print, and close. For example, clicking on a new starting button allows the customer to enter a new starting address to map out. Clicking on a directions button can display a step-by-step outline of navigational directions from the starting point to the retail store. Clicking on a print button can allow the user to print the map. Clicking on a close button closes the map and takes the user back to their previous page. Clicking on a directions button displays a step-by-step outline of navigational directions from the starting point to the retail store. Different user interface features for the directions page can include an outlined navigational directions, address of starting point and address of retail store. Outlined navigational directions can provide step-by-step instructions outlined from the starting point to the retail store.

FIG. 20 is a screenshot illustrating an exemplary interface for a map function expanded in full view for a mobile format according to one embodiment of the present invention. More specifically, this an example of the map feature expanded in full view for navigating to a selected retail store on a mobile device. As illustrated here, a map 2008 displays the location of the specified starting address to the retail store. A pathway is outlined between the two, according to the navigational directions provided. User interface buttons 2009 allow the user to either expand or collapse the map. Clicking on the directions button 2010 collapses the map and loads navigational directions on the right panel. Clicking on the product details button 2011 loads the product page for the currently selected product.

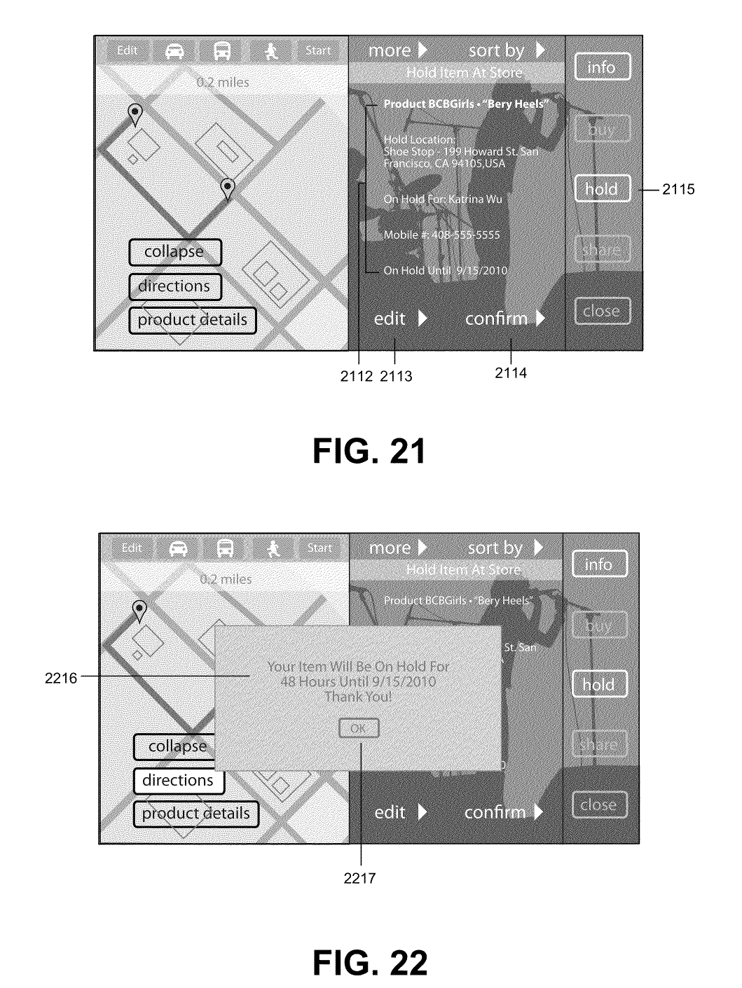

FIG. 21 is a screenshot illustrating an exemplary interface for a hold product function for a mobile format according to one embodiment of the present invention. This is an example of the in-store pickup feature for the mobile media player layout. The user is able to place a product on hold at a selected retail store listing from this page. An in-store pick up option allows a user to put a product on hold at a specified retail location. For example, clicking the hold button 2115 allows the user to place the currently selected product on hold at the selected retail store location. Once clicked, the user provides their contact information 2112 and selects specific product options. The contact information may be auto-filled and confirmed by clicking the confirm button 2114 or entered and/or edited by clicking the edit button 2113. Once submitted, a notification is sent to the retail store, for example through a VSA or other application supporting the media player, as an email, text message, or other message, etc., to hold the product, with the specified product options, under the user's provided contact information.

FIG. 22 is a screenshot illustrating an exemplary interface for a hold confirm feature for a mobile format according to one embodiment of the present invention. This is an example of the in-store pickup confirmation notice for a mobile phone. Once a hold request is made to a store, a confirmation pop up 2216 is displayed 016 to confirm that the store received the hold request. The user can close the pop up 2216 by clicking the “OK” button 2217. As described in the Related Application, an in-store pickup option allows the user to place the items in their shopping cart on hold at a local retail store location. There are different possible ways to get to this feature in the VSA. The user may click on the hold product button to display a list of different retail store locations that the products in the shopping cart may be sold at. Once a retail store location is selected, the user may place the products on hold under their name and phone number. The retail store can be notified to hold the product under the specified name and number. Another way to use this feature is when navigating the price comparison list. The user may select a retail store listing on the price comparison list and have the option to hold the product at the selected retail store listing. Yet another possible way of using the in-store pickup option is by way of the checkout section of the VSA. When the user select a payment type, during checkout, they may select in-store pickup. Once selected, a list of local retail stores that carry the products in their shopping cart can be displayed. The user may then select retail stores to hold their product for pickup.

A price comparison tool allows the user to select a product within the video and view a list of price listings for the product based on gathered web sites and retail locations. Web sites that sell the product are included in the listing as well as retail store locations that sell the product in their stores. The listing may be sorted according to price, name, type, ratings, etc. Different interface actions and options can be given for each listing, depending if the listing is from a web site or retail store.

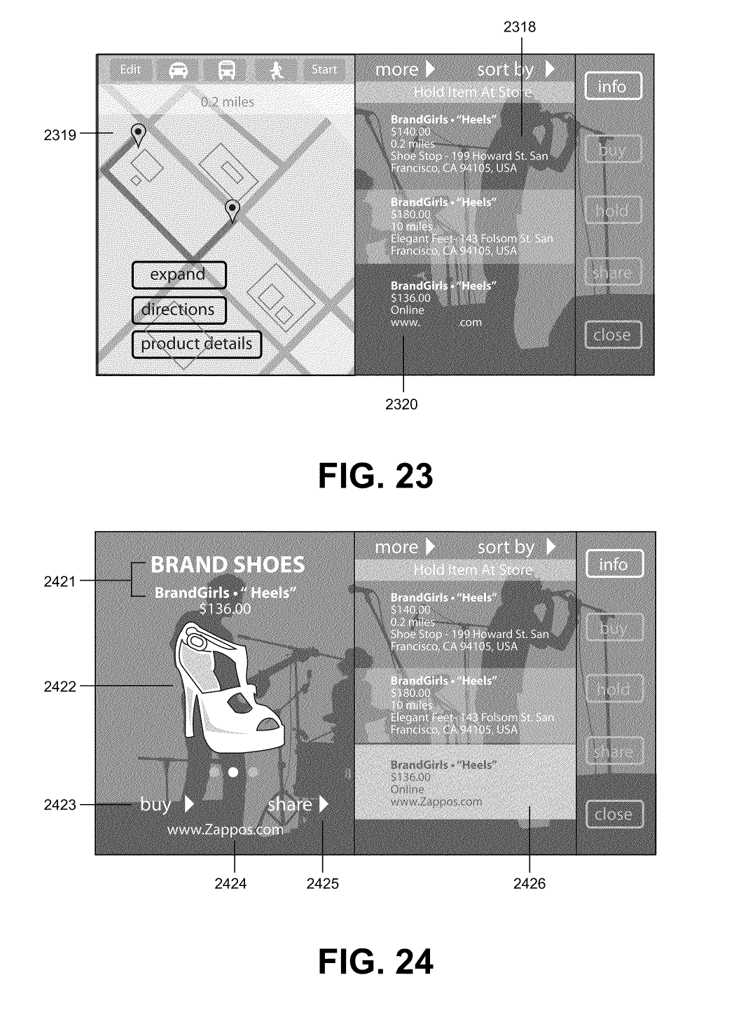

FIG. 23 is a screenshot illustrating an exemplary interface for a price comparison function for a mobile format according to one embodiment of the present invention. This specific example displays the layout when a retail store listing is selected. If a store listing is selected, a map 2319 to the store is displayed to the left of the list. The function of the price comparison feature on the mobile media player, when supported by a VSA, can be as described in the Related Application and summarized above. As noted therein, a price comparison tool allows a customer to compare the price of a product from merchants on the Internet and merchants selling the product at retail store locations. When a product is being viewed in the media player, the user may select the price comparison button to display a listing 2318 of different price points that the selected product may be sold at on the Internet an at retail store locations. The listing can be sorted by ratings, price, name and most popular. Clicking on a web listing 2320 can display the web sites product description, price and product options for the product. The user may also purchase the product from the web site without leaving the VSA. Clicking on a retail store location listing can display the product description, price and product options for the product as well. In addition to a store location listing, the user may view a map with directions to the retail store.

FIG. 24 is a screenshot illustrating an exemplary interface for a price comparison function for a mobile format according to one embodiment of the present invention. This specific example displays the layout when a web store listing 2426 is selected. If a web store listing is selected, a product page is displayed to the left of the list that can include a product name and price 2421, product picture 2422 an links or options such as a buy button 2423 to purchase the product, a share button 2425 to send the product information via email, SMS, MMS, etc. to another person, and a link 2424 to the web store.

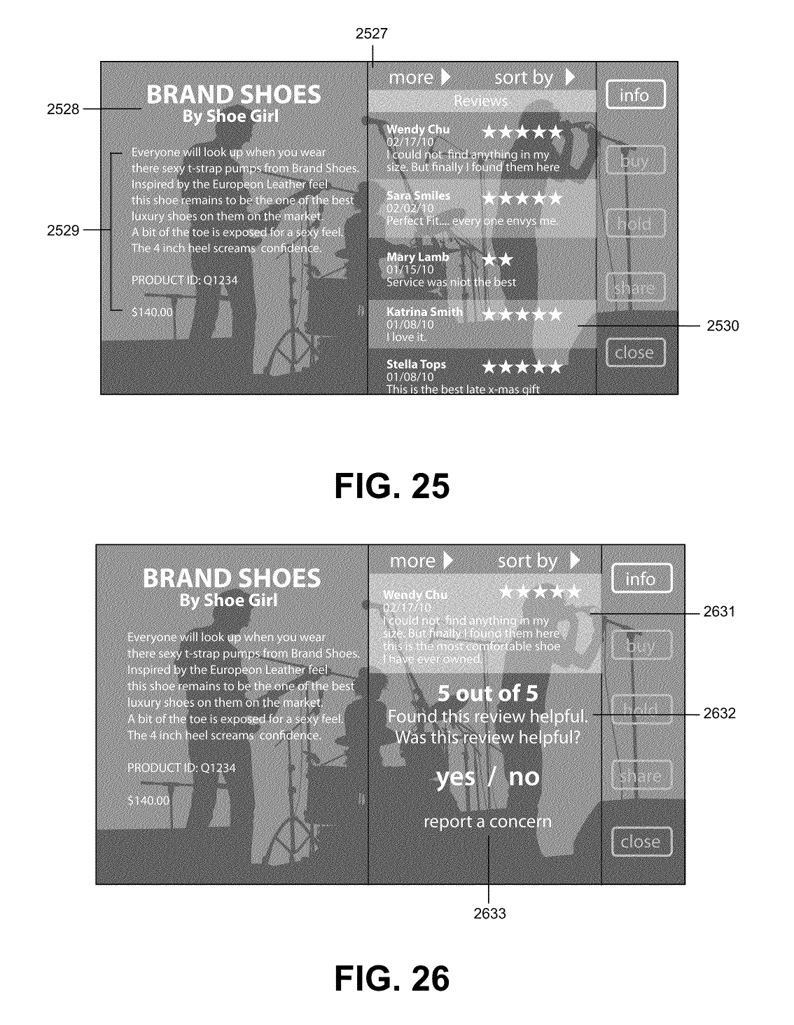

According to one embodiment, product and video rating tools allow the customer to view ratings, rate, and comment on a specific product or video. This can be done from a ratings panel or page within the media player. FIG. 25 is a screenshot illustrating an exemplary interface for a reviews function for a mobile format according to one embodiment of the present invention. The selected product name 2528 and description 2529 can be displayed on the left. User reviews for a selected product or video may be displayed in sortable list form 2527 to the right. Each listing can display the user name, date posted, subject line, comments, and rating score. Ratings can be scored under a 5-point rating system. Users may also vote on whether the rating/review was helpful or not. The function of the reviews feature on the mobile media player, when supported by a VSA, can be as described in the Related Application and summarized above.

FIG. 26 is a screenshot illustrating an exemplary interface for a reviews function for a mobile format according to one embodiment of the present invention. More specifically, this is an example of the reviews panel of FIG. 25 with a selected user review open. With a selected user review, the comments 2631 are displayed in full view and the user may vote 2632 if the review was helpful or not. The function of the reviews feature on the mobile media player, when supported by a VSA, can be as described in the Related Application and summarized above.

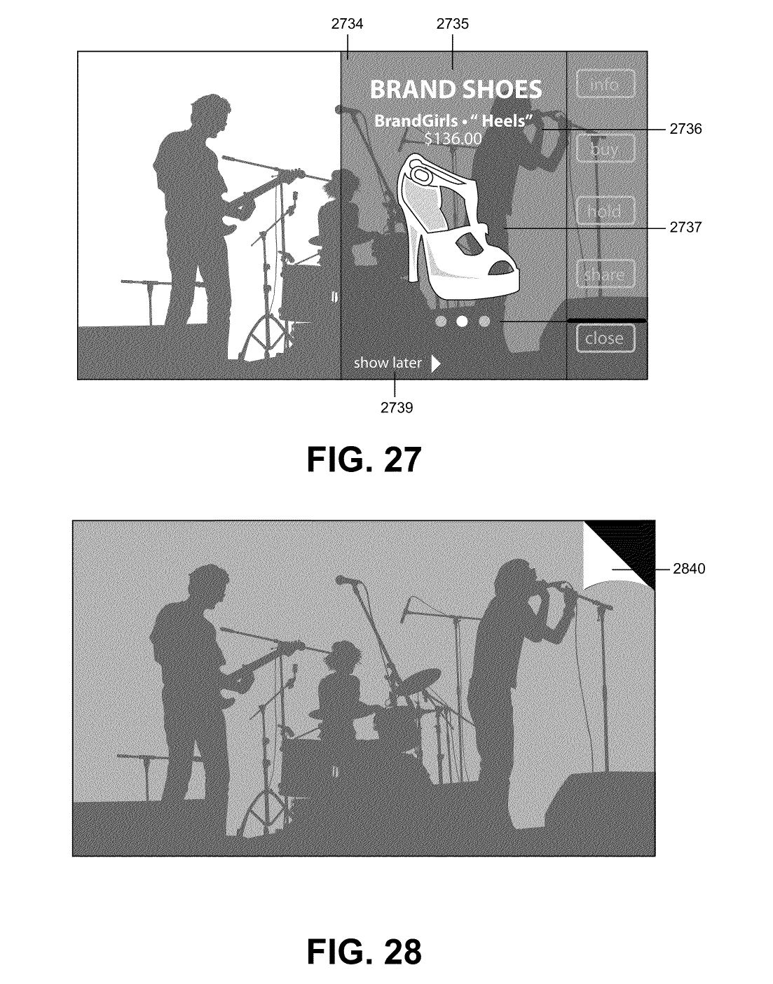

FIG. 27 is a screenshot illustrating an exemplary interface for a product page for a mobile format according to one embodiment of the present invention. This is an example of a product page panel 2734 on a mobile device layout. From this page the user may view the product image 2737, product name and base price 2736, brand 2735, and add the product to their shopping cart within the media player. If the user chooses to view the product after their video is done playing, they may click on the show later button 2739 to close the panel and add the product to their bookmarks.

FIG. 28 is a screenshot illustrating an exemplary interface for a page peel effect for a mobile format according to one embodiment of the present invention. This is an example of a page peel when a product is bookmarked, with the show later feature, to be viewed after the video is done playing. When the show later feature is activated, the user may continue to click on various tagged products throughout the video. Selected products are displayed, in a Page Peel Product Page, after the video is done and upon selection or activation, i.e., clicking, the page peel icon 2840.

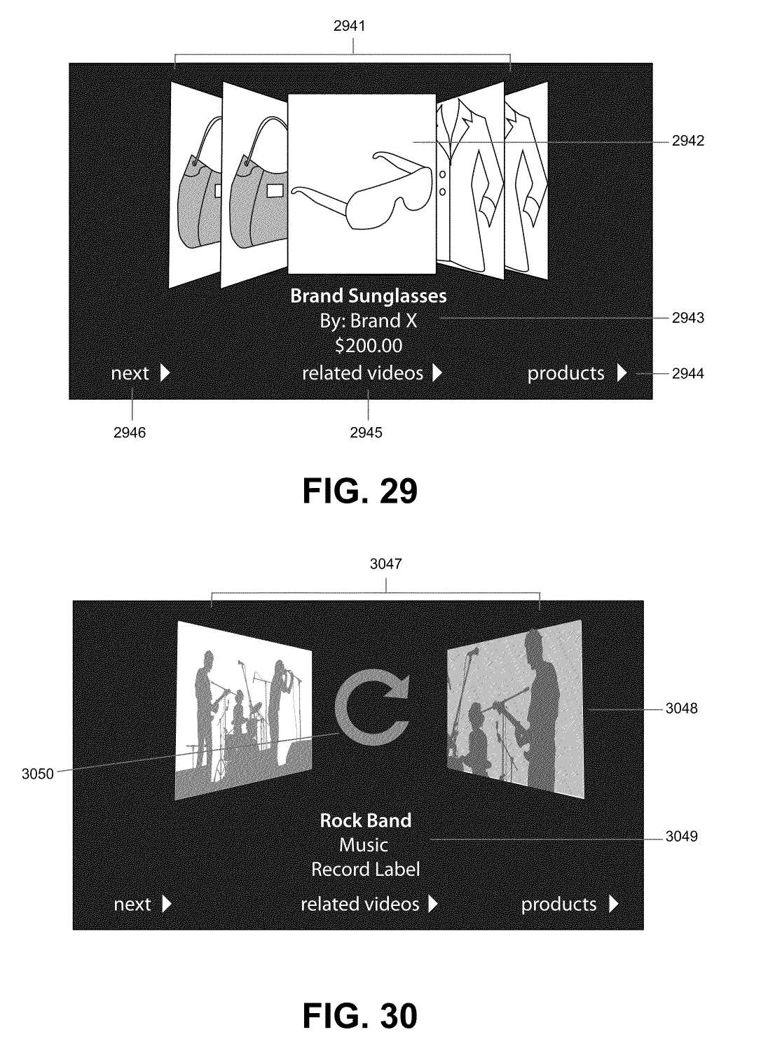

FIG. 29 is a screenshot illustrating an exemplary interface for a page peel product page for a mobile format according to one embodiment of the present invention. This is an example of a page peel product page as introduced above and filled with tagged products that the user has selected throughout watching their video, e.g., by clicking hotspots etc. as described above. Selected products are displayed in thumbnail form. It incorporates a product thumbnail view 2941 that allows the shuffling of products from left to right or right to left. The selected product thumbnail 2942 may be centered. Clicking on a product thumbnail may center it onto screen. The selected product thumbnail 2942 may have its product information 2943 loaded and displayed. Product thumbnails that are unselected may be displayed to the sides of the currently selected product thumbnail. Clicking on one of these product thumbnails may center it on screen and the product thumbnail may be currently selected. Additionally or alternatively, a next button 2946 can be used to scroll product thumbnails 2941. Clicking on a thumbnail 2942 or the products button 2944 can load the product page for the selected thumbnail as described above with reference to FIG. 27 for the selected product. A related videos button 2945 can be included that, upon selection by the user can cause a video clip related to the selected product thumbnail to play.

FIG. 30 is a screenshot illustrating an exemplary interface for a page peel related videos feature for a mobile format according to one embodiment of the present invention. This is an example of a related videos feature that loads at the end of the played video or in response to selection of the related videos button 2945. Videos related to the previous played video can be loaded here and represented in a set of thumbnails 3047 that allow the shuffling of videos/thumbnails from left to right or right to left. For a selected/highlighted thumbnail 3048, a name or description 3049 can be displayed and the video can be played in response to selection of a play button or icon 3050.

As described in the Related Application, users are allowed to share a product by distributing it as a VSA. As noted therein, from the share interface, the user may have the option to share a VSA with a product in it. The created VSA may then be distributed onto a personal web page, blog, social networking site application, mobile application, email or text message. Also as described in the Related Application, the request to create the new VSA can comprise receiving a request to create multi-generational VSA, i.e., to copy the first VSA of the requestor to a new VSA to be distributed or shared. To begin sharing product information from the media player, the user can select a product from the media player and press the share button.

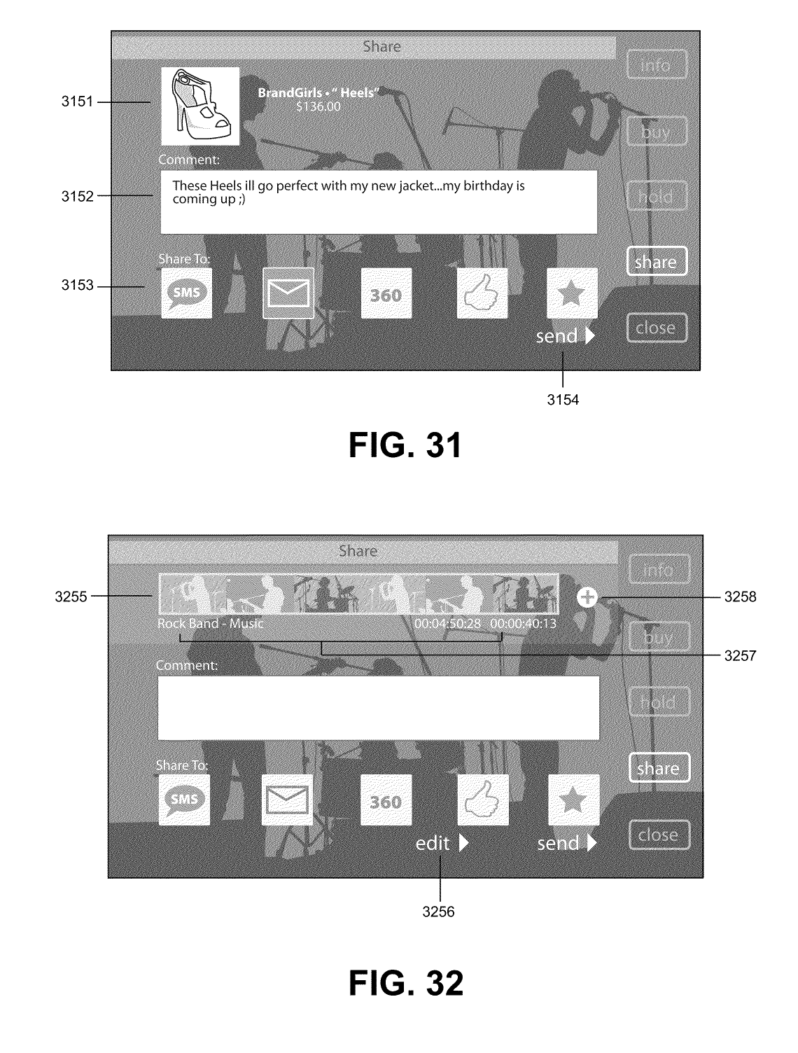

FIG. 31 is a screenshot illustrating an exemplary interface for a share product function for a mobile format according to one embodiment of the present invention. As illustrated in this example, the share product page can include an icon and product information 3151 for the selected product and a comment textbox 3152 or field in which the user can enter a message to be send with the shared product information. The page can also include a number of buttons 3153 or icons for selecting a form or media, e.g., a text message, email, blog post, social networking site post, etc., through which the product information will be shared. Upon selection of the send button 3154, the product information and any user messages can be sent via the selected media.

According to one embodiment, users can also share videos in a similar manner to how product information is shared. The video may be shared as a media player application that can be embedded onto a personal website, blog or social network site. In addition, a video may be shared through the use of a social networking site application and mobile phone application. Videos may be shared by a copied and pasted embed code for the media player application. When the user goes to share the video using embed code, an embed code can be generated that creates a playlist with the currently selected video in it. The embed code may be posted on the user's personal web page. The media player can then displayed with the video.

If the user wishes to share the video on a social networking site, they may be required to log into their social networking page within the media player. This can connect the users social networking account to the media player that will be shared on their social networking page. The video may be uploaded to their media player application on their social networking page. A channel can be created on the VSA media player application with the shared video in it. Visitors of the users social networking page can view the video from the VSA media player and take advantage of the features associated with it as described herein. If the user does not have the media player application installed on their social networking page, the user can be asked for permission to do so.

If the user wishes to share the video with another cell phone number as an SMS text message, they may do so with the text message share option. The user may input multiple mobile phone numbers to send the video to. Once phone numbers are provided, the video may be shared in various formats: SMS, MMS, and Mobile VSA Media Player App. As a SMS text message, the recipient may receive a text message with a specified message from the sender and a link to the shared video. Clicking on the link may have one of two actions take place. If the recipient does not have the mobile VSA media player application installed on their phone, clicking on the link may open a web browser on the users mobile phone that links the user to a web page hosting a media player with the shared video in the playlist. If the recipient does have the mobile VSA media player application installed on their phone, clicking on the link may open a channel page, within the mobile VSA media player app, that displays a media player with the selected shared video.

FIG. 32 is a screenshot illustrating an exemplary interface for a share video function for a mobile format according to one embodiment of the present invention. This is an example of a share video feature in the mobile media player layout. Users can be allowed to share a video or video clips in a similar way in which products are shared. Instead of distributing the shared video as its own VSA, the video can be distributed as its own media player. As illustrated here, the page includes a strip of thumbnail stills 3255 representing points in the video as well as identifying information 3258, e.g., video name, time markers, etc. A scroll button 3258 or icon can be used to advance through and select a portion of the video.

The user may also edit the clip by trimming it down using video editing tools in response to selecting or clicking the edit button 3256 or icon. The user may use video editing tools to highlight specific sections of the shared video. Before sharing the video, the user may edit the video by using tools to trim down the video into a smaller clip. The user may create a series of smaller clips within the same video or choose to only share a single clip. If multiple clips are shared, the clips are grouped into a single channel, of the shared video, within the media player. A media player is then created and shared with the specified clips and comments added by the user.

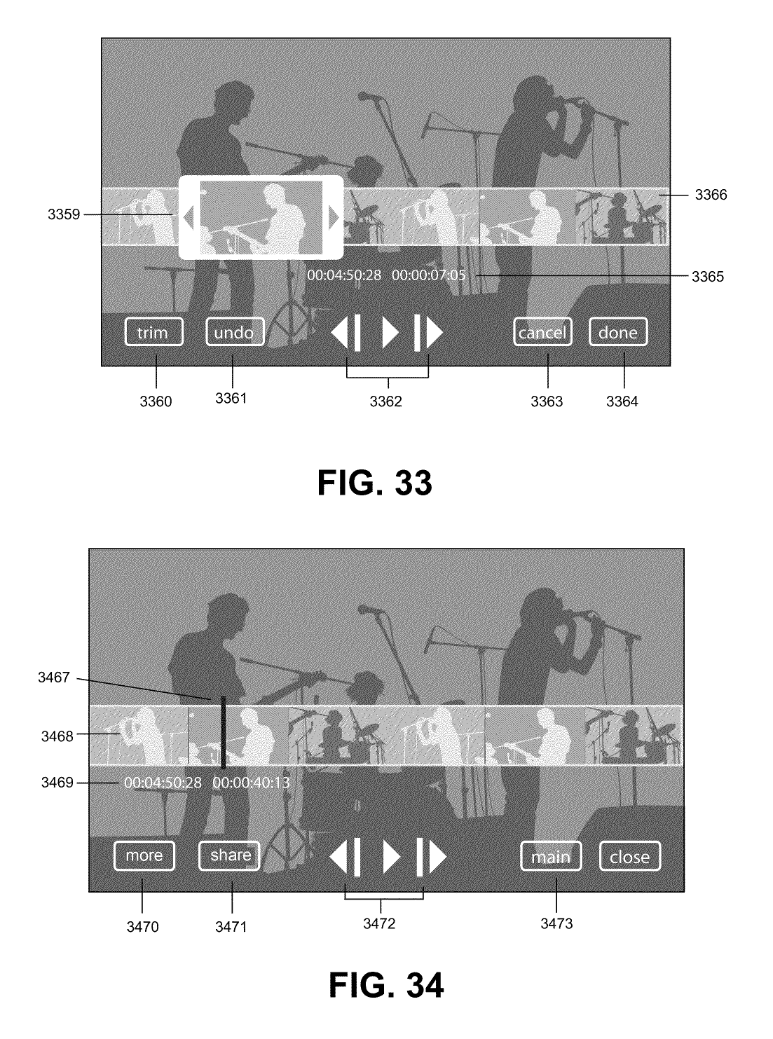

FIG. 33 is a screenshot illustrating an exemplary interface for an edit video function for a mobile format according to one embodiment of the present invention. This is an example of editing tools that can be used to edit the shared video selected in FIG. 32. The user may trim down video clips using various tools in this page. This interface can include a strip of thumbnail stills 3366 representing points in the video as well as identifying information 3365, e.g., a location (starting time) and duration of a selected portion of the video represented by the thumbnail. The interface can also include a selection indicator 3359 in the form of a frame that can be moved through the video to select a portion of the video represented by a thumbnail still. This frame can be moved through the thumbnails 3366 in response to user selection of one or more buttons 3362 or controls for advancing or rewinding through the video. The from can also itself include buttons or controls for expanding and/or contracting the selected portion of the video, i.e., the duration of the selected clip. The interface can also include a number of other buttons or controls including but not limited to a trim button 3360 for causing the tool to trim the video based on current selections, an undo button 3361 for reversing selections or edits made, a cancel buttons 3363 for canceling the editing process, and a done button 3364 for causing the edit to be made based on current selections. Once done, the video is added to a queue of clips to be shared in the share video feature as described above with reference to FIG. 32.

FIG. 34 is a screenshot illustrating an exemplary interface for a play video function for a mobile format according to one embodiment of the present invention. This is an example of play functions for the mobile media player layout. The video is divided up between a series of thumbnail clips 3468. Also displayed can be a current location marker 3467 illustrating a current point in the video clip and time information 3469 including duration and current location. There are multiple buttons 3472, e.g., rewind, play, fast forward, that allow the user to take control of the video using basic playback functions. In addition navigational buttons allow access to specific features including but not limited to a more button 3470 for presenting additional options, a share button 3471 for initiating a video sharing process as described above, and a main button 3473 for returning to a main or home interface page of the media player.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for providing an interactive media player, the method comprising:
generating with a commerce management server a media player including content area, the content area adapted to display a selected content;
displaying with the commerce management server the generated media player;
receiving at the commerce management server an indication of the selected content;
playing the selected content in the content area of the media player with the commerce management server;
selecting with the commerce management server an interactive ad based on the selected content; and
displaying the interactive ad with the commerce management server in a lower third banner of the content area during playout of the selected content.

2. The method of claim 1, further comprising generating with the commerce management server a content library of the media player and wherein displaying the generated media player includes displaying the content library.

3. The method of claim 2, further comprising generating with the commerce management server a favorites area of the media player based on a user of the media player and wherein displaying the generated media player includes displaying the favorites area.

4. The method of claim 1, wherein the interactive ad comprises a voting poll ad.

5. The method of claim 4, further comprising receiving a vote selection with the commerce management server from a user of the media player and presenting results for the voting poll with the commerce management server through the lower third banner.

6. The method of claim 1, wherein the interactive ad comprises survey ad.

7. The method of claim 1, wherein the interactive ad comprises a multiple choice question ad.

8. The method of claim 1, wherein the interactive ad comprises a written response questions.

9. The method of claim 1, wherein the interactive ad comprises a buy ad.

10. The method of claim 9, further comprising initiating with the commerce management server a purchase from the media player without causing the user to leaver the media player or stopping playout of the selected content.

11. The method of claim 10, wherein initiating the purchase is based on a user selection of a portion of the content area including a tagged product.

12. A system comprising:
a processor; and
a memory communicatively coupled with and readable by the processor and having stored therein a series of instructions which, when executed by the processor, cause the processor to providing an interactive media player by generating a media player including content area, the content area adapted to display a selected content, a content library of available content, and a favorites area of the media player based on a user of the media player, displaying the generated media player, receiving an indication of the selected content, playing the selected content in the content area of the media player, selecting an interactive ad based on the selected content, and displaying the interactive ad in a lower third banner of the content area during playout of the selected content.

13. The system of claim 12, wherein the interactive ad comprises a voting poll ad and further comprising receiving a vote selection with the commerce management server from a user of the media player and presenting results for the voting poll with the commerce management server through the lower third banner.

14. The system of claim 12, wherein the interactive ad is selected from a group consisting of a survey ad, a multiple choice question ad, a written response questions, and a buy ad.

15. The system of claim 14, wherein the interactive ad comprises a buy ad and further comprising initiating with the commerce management server a purchase from the media player without causing the user to leaver the media player or stopping playout of the selected content.

16. The system of claim 15, wherein initiating the purchase is based on a user selection of a portion of the content area including a tagged product.

17. A machine-readable medium having stored thereon a series of instructions which, when executed by a processor, cause the processor to provide an interactive media player by:
generating a media player including content area, the content area adapted to display a selected content, a content library of available content, and a favorites area of the media player based on a user of the media player;
displaying the generated media player;
receiving an indication of the selected content;
playing the selected content in the content area of the media player;
selecting an interactive ad based on the selected content; and
displaying the interactive ad in a lower third banner of the content area during playout of the selected content.

18. The machine-readable medium of claim 17, wherein the interactive ad comprises a voting poll ad and further comprising receiving a vote selection with the commerce management server from a user of the media player and presenting results for the voting poll with the commerce management server through the lower third banner.

19. The machine-readable medium of claim 17, wherein the interactive ad is selected from a group consisting of a survey ad, a multiple choice question ad, a written response questions, and a buy ad.

20. The machine-readable medium of claim 19, wherein the interactive ad comprises a buy ad and further comprising initiating with the commerce management server a purchase from the media player without causing the user to leaver the media player or stopping playout of the selected content.

21. The machine-readable medium of claim 20, wherein initiating the purchase is based on a user selection of a portion of the content area including a tagged product.
